(19) United States
(12) Patent Application Publication
(10) Pub. No.: US 2024/0237138 A1
(43) Pub. Date: Jul. 11, 2024

(54) TERMINAL, BASE STATION, CORE NETWORK DEVICE, AND WIRELESS COMMUNICATION METHOD

(71) Applicants: DENSO CORPORATION, Kariya-city (JP); TOYOTA JIDOSHA KABUSHIKI KAISHA, Toyota-shi (JP)

(72) Inventors: Haruhiko SOGABE, Kariya-city (JP); Hideaki TAKAHASHI, Kariya-city (JP)

(21) Appl. No.: 18/611,291

(22) Filed: Mar. 20, 2024

Related U.S. Application Data
(63) Continuation of application No. PCT/JP2022/036333, filed on Sep. 29, 2022.

(30) Foreign Application Priority Data
Sep. 30, 2021 (JP) 2021-162295

(51) Int. Cl. H04W 76/28; H04W 60/04; H04W 68/02; H04W 76/30

(52) U.S. Cl. CPC H04W 76/28; H04W 60/04; H04W 68/02; H04W 76/30

(57) ABSTRACT

A terminal includes a transmission unit configured to transmit a configuration request requesting configuration of an eDRX configuration value for an RRC inactive state, the eDRX configuration value including information indicating the number of candidates for a starting position of a reception period in a given H-SFN, a reception unit configured to receive second configuration information including the eDRX configuration value for the RRC inactive state, which is configured in response to the configuration request transmitted from the transmission unit, the eDRX configuration value including the information indicating the number of candidates for the starting position of the reception period in the given H-SFN, and a control unit configured to perform control such that the starting position of the reception period in the given H-SFN is specified according to the second configuration information received by the reception unit to perform eDRX in the RRC inactive state.

### CROSS-REFERENCE TO RELATED APPLICATION

This application is a continuation application of International Patent Application No. PCT/JP2022/036333, filed Sep. 29, 2022, which designated the U.S. and claims the benefit of priority to Japanese Patent Application No. 2021-162295 filed on Sep. 30, 2021. The entire contents of the above applications are incorporated herein by reference.

### TECHNICAL FIELD

The present disclosure relates to a terminal, a base station, a core network device, and a wireless communication method.

### BACKGROUND

In the Third Generation Participation Project (3GPP) which is an international standards organization, Release 15 that defines New Radio (NR) which is a Fifth Generation (5G) RAT is specified as a successor of a long-term evolution (LTE) which is a 3.9th generation radio access technology (RAT) and LTE-Advanced which is a 4th generation RAT, for example, Non-Patent Document 1: 3GPP TS 38.300 V15.11.0 (2020-09).

In addition, in the long-term evolution (LTE), a technology called extended Discontinuous Reception (eDRX) for reducing power consumption by restricting a period in which a wireless signal can be received, in consideration of the presence of a terminal whose power consumption is further restricted, such as an Internet of Things (IOT) device has been introduced, for example, Non-Patent Document 2: 3GPP TS 36.300 V15.12.0 (2020-12).

### SUMMARY

At present, in the 3GPP, examination of a function assuming a new terminal for IOT that performs radio access by using NR has begun. In addition, the above-described eDRX is also included in the function under examination. On the other hand, the 3GPP defines that UE has a plurality of RRC states. A mechanism for reducing power consumption in at least one of the plurality of states of the UE is desired to be further examined.

One object of the present disclosure is to provide a terminal, a base station, a core network device, and a wireless communication method capable of applying eDRX to a terminal in an RRC inactive state.

A terminal according to one aspect of the present disclosure includes a transmission unit configured to transmit a configuration request requesting configuration of an eDRX configuration value for an RRC inactive state, the eDRX configuration value including information indicating the number of starting positions of a reception period in a given H-SFN, a reception unit configured to receive second configuration information including the eDRX configuration value for the RRC inactive state, which is configured in response to the configuration request transmitted from the transmission unit, the eDRX configuration value including the information indicating the number of starting positions of the reception period in the given H-SFN, and a control unit configured to perform control such that the number of starting positions of the reception period in the given H-SFN coincides with the number indicated by the second configuration information received by the reception unit to perform eDRX in the RRC inactive state.

According to the present disclosure, it is possible to provide a terminal, a base station, a core network device, and a wireless communication method capable of applying eDRX to a terminal in an RRC inactive state.

### BRIEF DESCRIPTION OF DRAWINGS

FIG. 1 is a diagram illustrating an example of an outline of a wireless communication system according to the present embodiment.

FIG. 2 is a diagram illustrating an example of state transition of a terminal.

FIG. 3 is a diagram for describing a DRX operation at the time of paging.

FIG. 4 is a diagram for describing the eDRX operation at the time of paging.

FIG. 5 is a diagram illustrating an example of a processing procedure in a case where an eDRX parameter for an idle state and an eDRX parameter for an inactive state are managed in a core network.

FIG. 6 is a diagram illustrating an example of a processing procedure in a case where the eDRX parameter for the idle state is managed in the core network and the eDRX parameter for the inactive state is managed in a base station.

FIG. 7 is a diagram illustrating an example of a processing procedure in a case where the eDRX parameter for the idle state is managed in the core network and the eDRX parameter for the inactive state is managed in the base station.

FIG. 8 is a diagram illustrating an example of a processing procedure of paging in a case where the terminal is in the idle state or the inactive state.

FIG. 9 is a diagram illustrating a specification modification example of a 3GPP specification.

FIG. 10 is a diagram illustrating a specification modification example of the 3GPP specification.

FIG. 11 is a diagram illustrating a specification modification example of the 3GPP specification.

FIG. 12 is a diagram illustrating a specification modification example of the 3GPP specification.

FIG. 13 is a diagram illustrating a specification modification example of the 3GPP specification.

FIG. 14 is a diagram illustrating a specification modification example of the 3GPP specification.

FIG. 15 is a diagram illustrating a specification modification example of the 3GPP specification.

FIG. 16 is a diagram illustrating a specification modification example of the

3GPP specification.

FIG. 17 is a diagram illustrating a specification modification example of the 3GPP specification.

FIG. 18 is a diagram illustrating a specification modification example of the 3GPP specification.

FIG. 19 is a diagram illustrating a specification modification example of the 3GPP specification.

FIG. 20 is a diagram illustrating a specification modification example of the 3GPP specification.

FIG. 21 is a diagram illustrating a specification modification example of the 3GPP specification.

FIG. 22 is a diagram illustrating a specification modification example of the 3GPP specification.

FIG. 23 is a diagram illustrating a specification modification example of the 3GPP specification.

FIG. 24 is a diagram illustrating a specification modification example of the 3GPP specification.

FIG. 25 is a diagram illustrating a specification modification example of the 3GPP specification.

FIG. 26 is a diagram illustrating an example of a hardware configuration of each device in the wireless communication system.

FIG. 27 is a diagram illustrating an example of a functional configuration of the terminal.

FIG. 28 is a diagram illustrating an example of a functional configuration of the base station.

FIG. 29 is a diagram illustrating an example of a functional configuration of the core network.

### DETAILED DESCRIPTION

Hereinafter, the present embodiment will be described with reference to the drawings. In order to facilitate understanding of the description, the same reference numerals will be given to the same components in the drawings as much as possible, and repeated descriptions will be omitted.

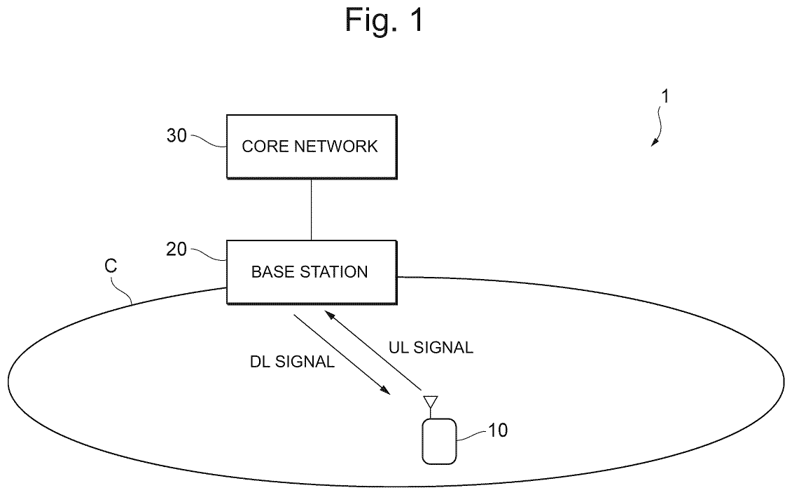

FIG. 1 is a diagram illustrating an example of an outline of a wireless communication system according to the present embodiment. As illustrated in FIG. 1, a wireless communication system 1 may include a terminal 10, a base station 20, and a core network 30. Note that, the numbers of terminals 10 and base stations 20 illustrated in FIG. 1 are merely examples, and are not limited to the numbers illustrated.

The wireless communication system 1 is a system that communicates in conformity with a radio access technology (RAT) defined by 3GPP. For example, although NR is assumed as the radio access technology which the wireless communication system 1 is in conformity with, the present embodiment is not limited thereto, and, for example, various RATs such as LTE, LTE-Advanced, or RAT of 6th generation or later can be used. Note that, the wireless communication system 1 may perform communication in conformity with a radio access technology defined by a standards organization different from 3GPP.

The terminal 10 is a device corresponding to a terminal (for example, user equipment (UE)) defined in a 3GPP specification. The terminal 10 is, for example, a given terminal or device such as a smartphone, a personal computer, a vehicle, an in-vehicle terminal, an in-vehicle device, a static device, a Telematics Control Unit (TCU), or an IoT device such as a sensor. The terminal 10 may be referred to as user equipment (UE), a mobile station (MS), a user terminal, a radio apparatus, a subscriber terminal, an access terminal, or the like. The terminal 10 may be a mobile type or a fixed type. The terminal 10 is capable of communicating by using, for example, the NR as the RAT. Note that, the terminal 10 is not limited to the terminal defined in the 3GPP specification, and may be a terminal in conformity with a standard defined by another standards organization. In addition, the terminal 10 does not have to be a terminal in conformity with a standard.

Here, in Release 17 of the NR, it is being examined to support functions for a terminal assuming performance or price range lower than terminals for Enhanced Mobile Broadband (eMBB) and Ultra-reliable and Low Latency Communications (URLLC) introduced in Release 15 or 16. The terminal is also referred to as a reduced capability (RedCap) terminal, a device, or the like, and is assumed to be used, for example, as an industrial wireless sensor, a video surveillance, a wearable device, or the like.

The RedCap terminal is assumed to have higher performance than a terminal for low power wide area communication (LPWA), and a carrier used by the RedCap terminal may have a bandwidth of 20 MHZ, 50 MHZ, 100 MHZ, or the like. Note that, the LPWA includes, for example, Category 0, Category 1, Long Term Evolution for Machine-type-communication (LTE-M), Narrow Band IoT (NB-IOT), and the like that operate in an RAT of an LTE system. A maximum bandwidth of Category 0 is 20 MHZ, a maximum bandwidth of Category 1 is 20 MHZ, a maximum bandwidth of LTE-M is 1.4 MHZ (6 RB), and a maximum bandwidth of NB-IOT is 180 kHz (1 RB). As described above, the RedCap terminal is assumed to be used as a terminal in a middle range between the terminals for eMBB and URLLC and the terminal for LPWA. The terminal 10 according to the present embodiment includes the RedCap terminal and the terminal for LPWA.

The base station 20 is a device corresponding to a base station (for example, gNodeB (gNB) or eNB) defined in the 3GPP specification. The base station 20 forms one or more cells C and communicates with the terminal 10 by using the cell C. The cell C may be referred to as a serving cell, a carrier, a component carrier (CC), or the like. The base station 20 may be referred to as gNodeB (gNB), en-gNB, a next generation-radio access network (NG-RAN) node, eNB, ng-eNB, a low-power node, a central unit (CU), a distributed unit (DU), gNB-DU, a remote radio head (RRH), integrated access and backhaul/backhauling (IAB) node, or the like. The base station 20 is not limited to one node, and may include a plurality of nodes (for example, a combination of a lower node such as a DU and a higher node such as a CU). Note that, the base station 20 is not limited to a base station defined in the 3GPP specification, and may be a base station in conformity with a standard defined by another standards organization. In addition, the base station 20 does not have to be a base station in conformity with a standard.

Although the core network 30 is, for example, a core network (5G core network (5GC)) corresponding to the NR, the present embodiment is not limited thereto. A device (hereinafter, also referred to as “core network device”) on the core network 30 performs mobility management of the terminal 10 such as paging and location registration of the terminal 10. The core network device may be connected to the base station 20 via a given interface (for example, S1 or NG interface). The base station 20 and/or the core network 30 may be referred to as a “network”.

The core network device includes, for example, at least one of a plurality of functions such as an access and mobility management function (AMF) that manages information regarding access, mobility management, and the like, a session management function (SMF) that manages a session, a user plane function (UPF) that controls transfer of a U-plane, and a network slice selection function (NSSF) that manages a network slice, and the like. Each of these functions is implemented in one or more physical or logical devices. Hereinafter, unless otherwise specified, the core network device is referred to as the core network 30 even in the case of indicating the core network device itself.

In the wireless communication system 1, the terminal 10 performs reception of a downlink (DL) signal from the base station 20 and/or transmission of an uplink signal (UL). One or more carriers may be configured for the terminal 10. A bandwidth of each carrier is, for example, 5 MHz to 400 MHZ. One or more bandwidth parts (BWPs) may be configured for one carrier. One BWP has at least a partial bandwidth of the carrier.

### UE State

Next, a radio resource control (RRC) state of the terminal 10 will be described. The RRC state of the terminal 10 includes an RRC Idle state (hereinafter, referred to as an “idle state”.), an RRC inactive state (hereinafter, referred to as an “inactive state”.), and an RRC connected state (hereinafter, referred to as a “connected state”.).

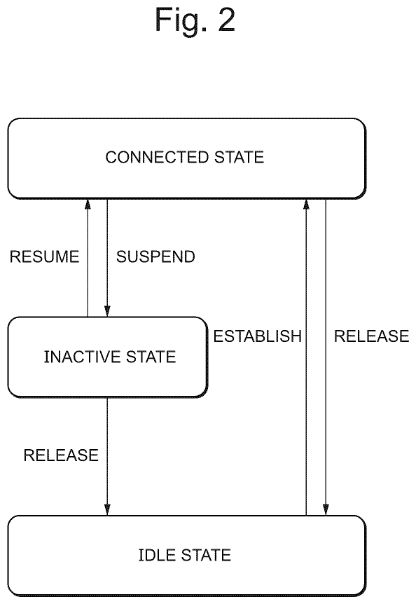

FIG. 2 is a diagram illustrating an example of a state transition of the terminal 10. In FIG. 2, the idle state is a state where an RRC connection between the terminal 10 and the base station 20 is not established, and is also referred to as RRC_IDLE, an idle mode, an RRC idle mode, or the like.

The terminal 10 in the idle state camps on a cell C selected by cell selection and/or cell reselection (hereinafter, referred to as “cell selection/reselection”), and receives system information broadcast by the cell C. When the RRC connection is established, the terminal 10 in the idle state transitions to the connected state.

The inactive state is a state where the RRC connection is established but is suspended, and is also referred to as RRC_INACTIVE, an inactive mode, an RRC inactive mode, or the like. The terminal 10 in the inactive state camps on to a cell C selected by cell selection/reselection, and receives system information broadcast by the cell C. In the inactive state, power saving of the terminal 10 can be achieved as in the idle state. However, unlike the idle state, context (RRC context and/or NAS context) of the terminal 10 is retained between the terminal 10, the base station 20, and the core network 30.

In addition, in the NR, a RAN notification area (RNA) which is an area obtained by subdividing a tracking area (TA) is newly defined, and the base station 20 manages the RAN notification area where there are the terminals 10 in the connected state and the inactive state. In addition, the NR has introduced a technology called “RAN paging” that performs paging processing in units of the RAN notification area, which is used in a case where the terminal 10 in the inactive state is called. In the RAN paging, paging signals are transmitted all at once from a plurality of base stations 20 constituting the RAN notification area where there is the terminal 10 in the inactive state. The terminal 10 in the inactive state which receives the paging signal resumes the RRC connection and transitions to the connected state.

The connected state is a state where the RRC connection is established, and is also referred to as RRC_CONNECTED, connected mode, RRC connected mode, or the like. The terminal 10 in the connected state monitors a physical downlink control channel (PDCCH), and controls reception of a physical downlink shared channel (PDSCH) based on detected downlink control information (DCI). The terminal 10 in the connected state transitions to the idle state when the RRC connection is released, and transitions to the inactive state when the RRC connection is suspended.

### eDRX Technology

Here, an enhanced DRX (eDRX) technology will be described. A subframe represents a time length of 1 ms, a radio frame represents a time length of 10 ms, and a hyperframe represents a time length of 10.24 seconds. A location of the radio frame is represented by a system frame number (SFN) from 0 to 1023. In addition, in order to manage a time longer than 1024 radio frames, the hyperframe which has a length of SFN from 0 to 1023 (that is, 10.24 seconds) is defined. The hyperframe is represented by a hyper-SFN (H-SFN) from 0 to 1023. H-SFN is also referred to as a hyper frame number (HFN).

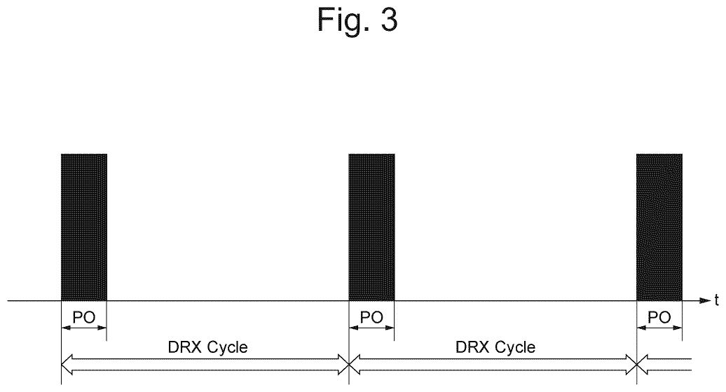

FIG. 3 is a diagram for describing a discontinuous reception (DRX) operation at the time of paging. As illustrated in FIG. 3, the terminal 10 in the idle state receives a paging signal by monitoring downlink control channel candidates (PDCCH candidates) in a period called a paging occasion (PO). While the terminal 10 is operating according to a DRX configuration, the base station 20 transmits a paging signal in a PO period, and does not transmit a paging signal in other periods. The terminal 10 that receives the paging signal within the PO period establishes communication with the base station 20, and transitions to the connected state. There is one PO for each DRX cycle. A maximum DRX cycle is 2.56 seconds.

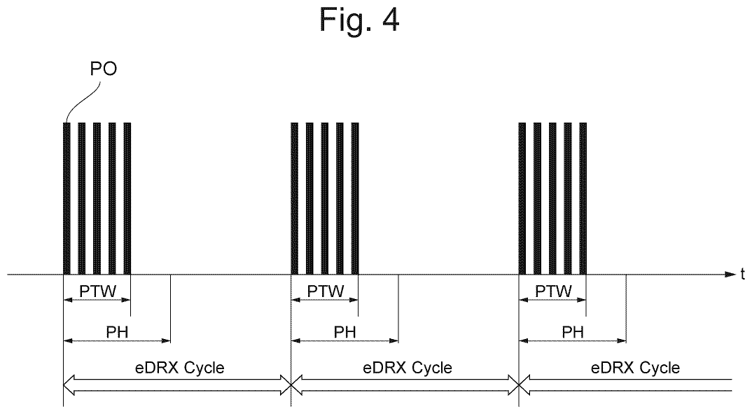

FIG. 4 is a diagram for describing an eDRX operation at the time of paging. As illustrated in FIG. 4, the terminal 10 in the idle state receives a paging signal by monitoring downlink control channel candidates in a PO period present within a period called paging time window (PTW). One PTW is configured within a hyperframe called paging hyperframe (PH). There is one PH for each eDRX cycle. The eDRX cycle can be configured in a maximum of 2.91 hours (that is, 1024 hyperframes) in the case of the terminal 10 which is the NB-IoT, and can be configured in a maximum of approximately 44 minutes (that is, 256 hyperframes) in the case of the terminal 10 other than the NB-IoT.

While the terminal 10 is operating according to an eDRX configuration, the base station 20 transmits a paging signal in a PTW period and a PO period, and does not transmit a paging signal in other periods. The terminal 10 that receives the paging signal establishes communication with the base station 20, and transitions to the connected state.

Here, the PH may be an H-SFN that satisfies the following Formula 1.

$$H - SFN mod TeDRX , H = ( UE\_ID \_H mod TeDRX , H ) \qquad Formula 1$$

TeDRX, H″ represents an eDRX cycle, and is configured to have a length that is an integral multiple of a hyperframe. UE_ID_H is most significant 10 or 12 bits of a hashed ID determined based on SAE Temporary Mobile Subscriber Identity (S-TMSI) or 5G S-Temporary Mobile Subscriber Identity (5G-S-TMIS).

An SFN which is a starting position (PTW_start) (start timing) of the PTW may be expressed by the following Formulas 2 and 3.

$$\begin{matrix}SFN = 256 * ieDRX & Formula 2 \\ ieDRX = floor ( UE\_ID \_H / TeDRX , H ) mod 4 & Formula 3\end{matrix}$$

An SFN which is an ending position (PTW_end) (end timing) of the PTW may be expressed by the following Formula 4.

$$SFN = ( PTW\_start + L * 100 - 1 ) mod 1024 \qquad Formula 4$$

L is a time length (paging time window length) of the PTW. Parameters (hereinafter, referred to as “eDRX parameters”) that determine the eDRX operation, such as the eDRX cycle and the time length of the PTW are configured for the terminal 10 with a message from a higher layer (Non Access Stratum (NAS)). Hereinafter, the “PTW” means the time length of the PTW unless otherwise specified.

In addition, the terminal 10, the base station 20, and the core network 30 according to the present embodiment may flexibly configure the starting position of the PTW by including, in the eDRX parameters, given information regarding a configuration of the starting position of the PTW. For example, information indicating the number of starting positions of the PTW (the number of SFNs that can be configured as a start SFN of the PTW) in the PH may be included in the given information regarding the configuration of the starting position of the PTW, and the starting position of the PTW may be determined by inputting the information indicating the number of starting positions of the PTW in the PH to given calculation formulas. The given calculation formulas may be Formulas 5 and 6 below. In addition, the ending position of the PTW may be determined according to Formula 4 as in the LTE.

$$\begin{matrix}SFN = ( 1024 div NPTW ) * ieDRX & Formula 5 \\ ieDRX = floor ( UE\_ID \_H / TeDRX , H ) mod NPTW & Formula 6\end{matrix}$$

In Formulas 5 and 6, NPTW is information indicating the number of starting positions of the PTW in the PH. In other words, the NPTW is information for specifying the number of candidates for the starting position of the PTW in the PH, and can be said to be a parameter for varying the number of candidates for the starting position of the PTW in the PH. The NPTW may be information for specifying the number of starting positions of the PTW in the PH. For example, in the case of NPTW=8, since a possible value of ieDRX is 0 to 7, the starting position of the PTW is any of eight values of SFN=0, 128, 256, 384, 512, 640, 768, and 896. Note that, in the case of NPTW=4, Formulas 5 and 6 are the same as Formulas 2 and 3, respectively. That is, Formulas 5 and 6 are used, and thus, the starting position of the PTW can be configured more flexibly than in the LTE.

In a case where the starting position of the PTW is determined according to Formulas 5 and 6 and the ending position of the PTW is determined by Formula 4, the eDRX cycle (TeDRX, H in Formula 6), the time length of the PTW (L in Formula 4), and the number of starting positions of the PTW in the PH (NPTW in Formula 5) are included in the eDRX parameters.

In addition, in the wireless communication system 1 according to the present embodiment, the given information regarding the configuration of the starting position of the PTW may include information indicating a radio frame indicating the starting position of the PTW. For example, the information indicating the radio frame indicating the starting position of the PTW may be information indicating a specific radio frame number, such as SFN=0 or SFN=64. In addition, the eDRX parameters may include information (for example, SFN=64, SFN=128, or the like) indicating a radio frame indicating the ending position of the PTW. Accordingly, the ending position of the PTW can be flexibly configured. In this case, the eDRX parameters include the eDRX cycle, the information indicating the radio frame indicating the starting position of the PTW, and the information indicating the radio frame indicating the ending position of the PTW.

### Issues when eDRX is Realized in NR

At present, in the 3GPP, examination for realizing the eDRX in the NR are underway. However, the current 3GPP does not define a processing procedure required to apply the eDRX to the terminal 10 in the idle state, such as the configuration of the eDRX parameters (first issue). Similarly, the current 3GPP also does not define a processing procedure required to apply the eDRX to the terminal 10 in the inactive state (second issue).

In the present embodiment, in order to solve the first issue, in order for the terminal 10 to perform the eDRX operation in the idle state, the eDRX parameter applied to the terminal 10 in the idle state can be configured for the terminal 10 and the network. In addition, in the present embodiment, in order to solve the second issue, in order for the terminal 10 to perform the eDRX operation in the inactive state, the eDRX parameter applied to the terminal 10 in the inactive state can be configured for the terminal 10 and the network.

In the following description, the “eDRX parameters” may mean only a parameter that determines the eDRX operation, such as the eDRX cycle or the time length of the PTW, or the number of starting positions of the PTW in the PH, or may mean a parameter that determines the DRX operation such as the configuration of the DRX cycle or the PO location in addition to the parameter that determines the eDRX operation. A message for transmitting the “eDRX parameters” has regions of 4 octets, and the “eDRX parameters” may be stored in regions of 2 octets out of 4 octets. In addition, the “eDRX parameter” for the inactive state means the eDRX parameter applied to the terminal 10 in the inactive state. In addition, the “eDRX parameter” for the idle state means the eDRX parameter applied to the terminal 10 in the idle state.

### Processing Procedure when eDRX is Realized in Idle State or Inactive State

When the eDRX is realized in the idle state or the inactive state, two methods of a method for managing the “eDRX parameter” for the idle state and the “eDRX parameter” for the inactive state in the core network 30 and a method for managing the eDRX parameter in the base station 20 can be considered.

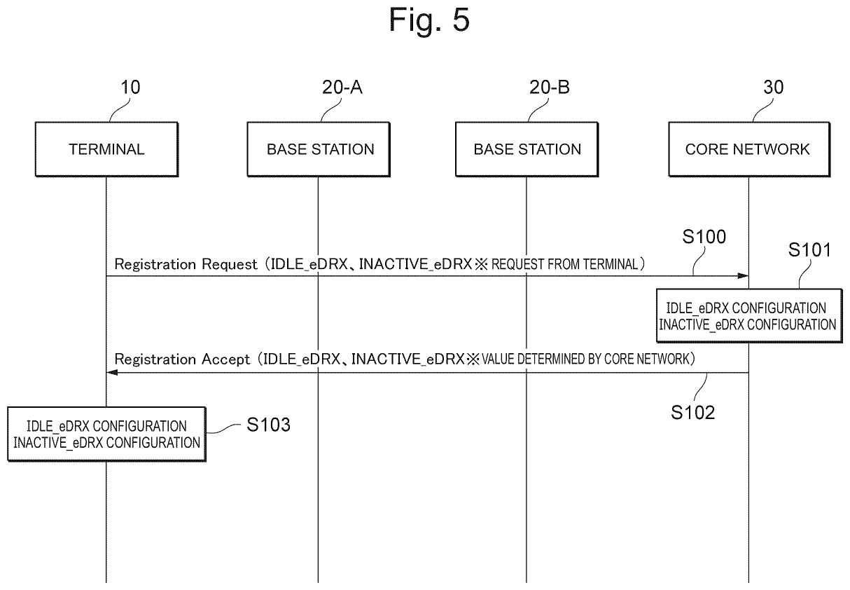

FIG. 5 is a diagram illustrating an example of a processing procedure in a case where the “eDRX parameter” for the idle state and the “eDRX parameter” for the inactive state are managed in the core network 30. Note that, although the core network 30 is assumed to have, for example, the AMF, the core network 30 is not limited thereto.

The terminal 10 that desires validation of the eDRX transmits, to the core network 30, a registration request message including the “eDRX parameter” indicating the eDRX operation desired (requested) to be configured (S100). For example, the terminal 10 that desires the eDRX operation in which the eDRX cycle is 2 hyperframes, the PTW is 1.28 seconds, and the number of starting positions of the PTW is 8 transmits, to the core network 30, a registration request including the eDRX parameter indicating that the eDRX cycle is 2 hyperframes, the PTW is 1.28 seconds, and the number of starting positions of the PTW is 8.

Here, the terminal 10 may distinguishably include, in the registration request message, the “eDRX parameter” indicating the eDRX operation for the idle state and the “eDRX parameter” indicating the eDRX operation for the inactive state. For example, it is assumed that the terminal 10 desires (requests) the eDRX operation in which the eDRX cycle is 10 hyperframes, the PTW is 2 seconds, and the number of starting positions of the PTW is 8 in the idle state and desires (requests) the eDRX operation in which the eDRX cycle is 4 hyperframes, the PTW is 1 second, and the number of starting positions of the PTW is 4 in the inactive state. In this case, the terminal 10 may transmit, to the core network 30, the “eDRX parameter” for the idle state indicating that the eDRX cycle in the idle state is 10 hyperframes, the PTW is 2 seconds, and the number of starting positions of the PTW is 8 and the “eDRX parameter” for the inactive state indicating that the eDRX cycle in the inactive state is 4 hyperframes, the PTW is 1 second, and the number of starting position of the PTW is 4.

In addition, in a case where the terminal 10 desires (requests) that the “eDRX parameter” for the inactive state may be the same as the “eDRX parameter” for the idle state, the terminal 10 may explicitly or implicitly include, in the registration request message, information indicating that the eDRX parameter for the inactive state has the same value as the eDRX parameter for the idle state. For example, in a case where the registration request message includes the eDRX parameter for the idle state but does not include the eDRX parameter for the inactive state (for example, in a case where nothing is configured in the eDRX parameter for the inactive state, or a given character string or a given numerical value such as “absent” or “NULL” is configured in the eDRX parameter), the information may imply that the eDRX parameter for the inactive state is the same as the eDRX parameter for the idle state. Note that, the information indicating that the eDRX parameter for the inactive state has the same value as the eDRX parameter for the idle state may be configured for each eDRX parameter.

Subsequently, the core network 30 determines (configures) the “eDRX parameter” for the idle state and the “eDRX parameter” for the inactive state based on the registration request received from the terminal 10 (S101). The core network 30 determines the “eDRX parameter” for the idle state to be configured for the terminal 10 and the “eDRX parameter” for the inactive state in consideration of, for example, the eDRX parameter received from the terminal 10, a load of the network, an attribute of the terminal 10, capability of the terminal 10, and/or the like. The core network 30 may determine the “eDRX parameter” configured for the terminal 10 to have the same value as the “eDRX parameter” included in the registration request, or may determine the “eDRX parameter” configured for the terminal 10 to have a value different from the “eDRX parameter” included in the registration request. The core network 30 may determine the “eDRX parameter” for the idle state and the “eDRX parameter” for the inactive state such that the PTW starting position in the idle state and the PTW starting position in the inactive state are the same.

Subsequently, in order to configure the determined “eDRX parameters” for the terminal 10, the core network 30 transmits, to the terminal 10, a registration accept message including the determined “eDRX parameter” for the idle state and the determined “eDRX parameter” for the inactive state (S102). Note that, in a case where the determined “eDRX parameter” for the idle state and the determined “eDRX parameter” for the inactive state are the same, the core network 30 may explicitly or implicitly include, in the registration accept message, the information indicating that the “eDRX parameter” for the inactive state has the same value as the “eDRX parameter” for the Idle state. For example, in a case where the registration accept message includes the “eDRX parameter” for the idle state but does not include the “eDRX parameter” for the inactive state (for example, in a case where the eDRX parameter is “absent”), the information may imply that the “eDRX parameter” for the inactive state is the same as the “eDRX parameter” for the idle state.

The terminal 10 configures the “eDRX parameter” for the idle state and the “eDRX parameter” for the inactive state which are included in the registration accept message (stores the “eDRX parameters” in a storage device 12) (S103). Note that, the information indicating that the “eDRX parameter” for the inactive state has the same value as the “eDRX parameter” for the idle state is explicitly or implicitly included in the registration accept message, the terminal 10 may recognize that the “eDRX parameter” for the inactive state has the same value as the “eDRX parameter” for the idle state. In this case, the terminal 10 may configure the same value as the “eDRX parameter” for the idle state to the “eDRX parameter” for the inactive state. Note that, the registration request message and the registration accept message described above are examples, and may be any message as long as the message is the NAS message.

In a case where the terminal 10 is in the idle state, the terminal 10 monitors control channel candidates within a paging search space with the PTW in the PH indicated by the configured “eDRX parameter” for the idle state. In addition, when a paging message is transmitted to the terminal 10 in the idle state, the base station 20 transmits DCI within the paging search space with the PTW in the PH indicated by the “eDRX parameter” for the idle state configured for the terminal 10. In addition, in a case where the terminal 10 is in the inactive state, the terminal 10 monitors the control channel candidates within the paging search space with the PTW in the PH indicated by the configured eDRX parameter for the inactive state. In addition, when the paging message is transmitted to the terminal 10 in the inactive state, the base station 20 transmits DCI within the paging search space with the PTW in the PH indicated by the “eDRX parameter” for the inactive state configured for the terminal 10.

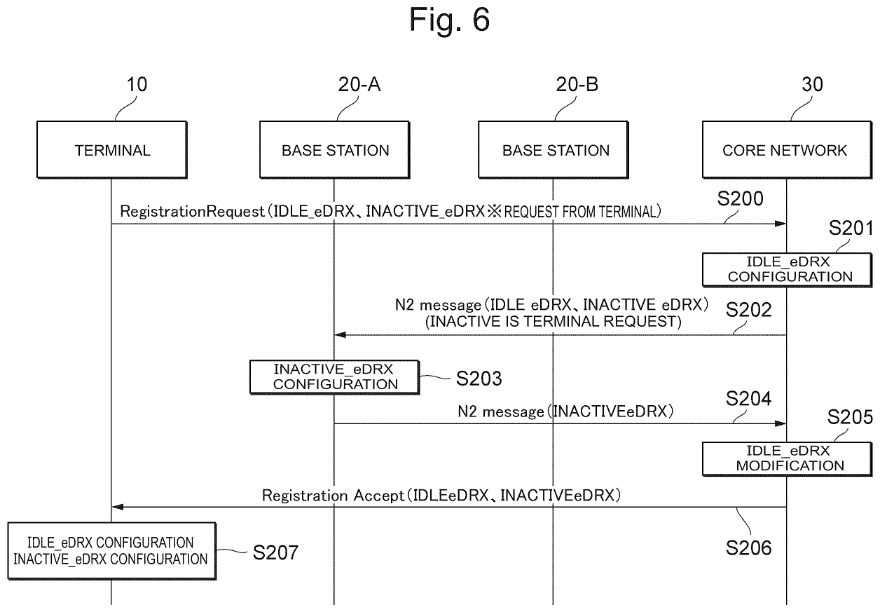

FIG. 6 is a diagram illustrating an example of a processing procedure in a case where the “eDRX parameter” for the idle state is managed in the core network 30 and the “eDRX parameter” for the inactive state is managed in the base station 20. Note that, it is assumed that a base station 20-A is the base station 20 (serving base station) that communicates with the terminal 10 and a base station 20-B is the base station 20 adjacent to the base station 20-A.

The terminal 10 that desires the validation of the eDRX transmits, to the core network 30, the registration request message including the “eDRX parameter” indicating the eDRX operation desired (requested) to be configured (S200). Here, the terminal 10 may distinguishably include, in the registration request message, the “eDRX parameter” for the idle state desired (requested) to be configured and the “eDRX parameter” for the inactive state desired (requested) to be configured.

In addition, in a case where the terminal 10 desires (requests) that the “eDRX parameter” for the inactive state may be the same as the “eDRX parameter” for the idle state, the terminal 10 may explicitly or implicitly include, in the registration request message, the information indicating that the “eDRX parameter” for the inactive state has the same value as the “eDRX parameter” for the idle state. For example, in a case where there is information (for example, a name of an information element that stores the eDRX parameter) indicating that the “eDRX parameter” for the inactive state is requested in the registration request message but a specific eDRX parameter is not included (that is, a case where the eDRX parameter is “absent”), the information may imply that the eDRX parameter for the inactive state is the same as the eDRX parameter for the idle state.

Subsequently, the core network 30 determines (configures) the “eDRX parameter” for the idle state based on the registration request received from the terminal 10 (S201). The core network 30 may determine the “eDRX parameter” for the idle state while referring to the “eDRX parameter” for the inactive state received from the terminal 10. For example, the core network 30 may determine the “eDRX parameter” for the idle state such that the PTW starting position in the idle state is the same as the PTW starting position calculated by the “eDRX parameter” for the inactive state desired (requested) to be configured by the terminal 10. In addition, the core network 30 transmits to, the base station 20-A, a message including the determined “eDRX parameter” for the idle state and the “eDRX parameter” for the inactive state indicating the eDRX operation desired (requested) to be configured by the terminal 10, which is transmitted from the terminal 10 to the core network 30 (S202).

Specifically, in order to notify the base station 20-A of information necessary for the base station 20 to communicate with the terminal 10, the core network 30 transmits an initial context setup request message to the base station 20-A. Here, the core network 30 notifies the base station 20 of the “eDRX parameter” for the idle state determined by the core network 30 and the “eDRX parameter” for the inactive state indicating the eDRX operation desired (requested) to be configured by the terminal 10. Thus, the core network 30 includes the eDRX parameter for the idle state and the “eDRX parameter” for the inactive state in the initial context setup request, and transmits the eDRX parameters. Note that, the eDRX parameter for the idle state and the “eDRX parameter” for the inactive state are included in the initial context setup request. The eDRX parameters may be a part of core network assistance information for RRC inactive. Note that, the messages transmitted and received between the base station 20 and the core network 30 are called N2 messages. In addition to the initial context setup request message, a UE context modification request message, a handover request message, a path switch request acknowledge message, and the like are included in the N2 messages. The core network 30 may include the eDRX parameter for the idle state and the “eDRX parameter” for the inactive state in these N2 messages, and may transmit these N2 messages to the base station 20-A. The N2 message including the eDRX parameter for the idle state is received, and thus, the base station 20-A can recognize the eDRX parameter for the idle state configured for the terminal 10. In addition, the N2 message including the eDRX parameter for the inactive state is received, and thus, the base station 20-A can recognize the eDRX parameter for the inactive state desired (requested) to be configured by the terminal 10.

Subsequently, the base station 20-A determines the eDRX parameter for the inactive state based on the message received from the core network 30 (S203). In this case, the base station 20-A may determine the “eDRX parameter” for the inactive state while referring to the “eDRX parameter” for the idle state received from the core network 30. For example, the base station 20-A may determine the “eDRX parameter” for the inactive state such that the PTW starting position in the inactive state is the same as the PTW starting position calculated by the “eDRX parameter” for the idle state received from the core network 30. In addition, the base station 20-A transmits the message including the determined “eDRX parameter” for the inactive state to the core network 30 (S204).

Specifically, the base station 20-A transmits, to the core network 30, an initial context setup response message which is a response message to the initial context setup request. Here, in order to notify the core network 30 of the “eDRX parameter” for the inactive state determined by the base station 20-A, the base stations 20-A include the eDRX parameter for the inactive state in the initial context setup response, and transmits the eDRX parameter for the inactive state. Note that, the eDRX parameter for the inactive state may be a part of the core network assistance information for RRC inactive included in the initial context setup response. In addition to the initial context setup response message, a UE context modification response message, a handover request acknowledge message, a path switch request message, and the like are included in the N2 messages. The base station 20-A may include the eDRX parameter for the inactive state in these N2 message, and may transmit the eDRX parameter for the inactive state to the core network 30.

Subsequently, in a case where the PTW starting position calculated from the “eDRX parameter” for the idle state determined in step S201 described above and the PTW starting position calculated from the “eDRX parameter” for the inactive state included in the message received from the base station 20-A are different, the core network 30 may modify the “eDRX parameter” for the idle state such that the PTW starting position in the idle state is the same as the PTW starting position calculated by the “eDRX parameter” for the inactive state. For example, the core network 30 may perform modification such that the “eDRX parameter” for the idle state coincides with the “eDRX parameter” for the inactive state (S205). In addition, for example, the core network 30 may modify the “eDRX parameter” for the idle state such that the number of starting positions of the PTW in the PH indicated by the “eDRX parameter” for the idle state is the same as the number of starting positions of the PTW in the PH indicated by the “eDRX parameter” for the inactive state in a case where the number of starting positions of the PTW in the PH indicated by the “eDRX parameter” for the idle state and the number of starting positions of the PTW in the PH indicated by the “eDRX parameter” for the inactive state are the same by setting the starting positions of the PTWs to be the same.

Subsequently, in order to configure the determined “eDRX parameter” for the terminal 10, the core network 30 transmits, to the terminal 10, the registration accept message including the determined “eDRX parameter” for the idle state and the “eDRX parameter” for the inactive state (S206). Note that, in a case where the “eDRX parameter” for the inactive state is the same as the “eDRX parameter” for the idle state, the core network 30 may explicitly or implicitly include, in the registration accept message, the information indicating that the “eDRX parameter” for the inactive state has the same value as the “eDRX parameter” for the idle state. For example, in a case where a case where there is information (for example, a name of an information element that stores the eDRX parameter) indicating that there is the “eDRX parameter” for the inactive state in the registration accept message but a specific eDRX parameter is not included (that is, a case where the eDRX parameter is “absent”), the information may imply that the eDRX parameter for the inactive state is the same as the eDRX parameter for the idle state.

The terminal 10 configures the “eDRX parameter” for the idle state and the “eDRX parameter” for the inactive state included in the registration accept message (stores the “eDRX parameters” in the storage device 12) (S207).

Thereafter, as in the description of FIG. 5, the terminal 10 monitors the control channel candidates within the paging search space with the PTW in the PH indicated by the configured eDRX parameter for the idle state or the configured eDRX parameter for the inactive state. In addition, when the paging message is transmitted, the base station 20-A transmits the DCI within the paging search space with the PTW in the PH indicated by the eDRX parameter for the idle state or the eDRX parameter for the inactive state.

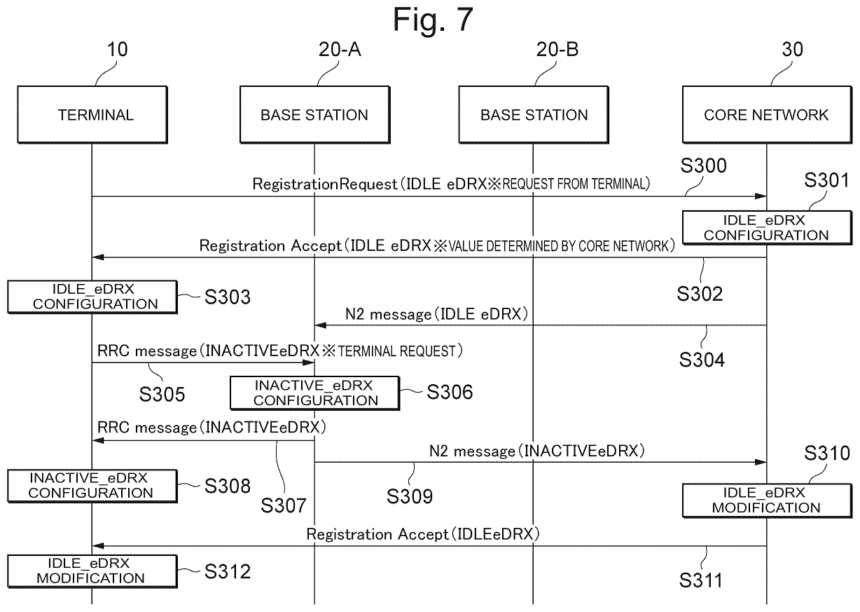

FIG. 7 is a diagram illustrating an example of a processing procedure in a case where the “eDRX parameter” for the idle state is managed in the core network 30 and the “eDRX parameter” for the inactive state is managed in the base station 20-A.

The terminal 10 that desires the validation of the eDRX transmits, to the core network 30, the registration request message including the “eDRX parameter” indicating the eDRX operation desired (requested) to be configured (S300). Here, the terminal 10 may include, in the registration request message, the “eDRX parameter” for the idle state desired (requested) to be configured.

Subsequently, the core network 30 determines the “eDRX parameter” for the idle state based on the registration request received from the terminal 10 (S301).

Subsequently, in order to configure the determined “eDRX parameter” for the terminal 10, the core network 30 transmits, to the terminal 10, the registration accept message including the determined “eDRX parameter” for the idle state (S302).

The terminal 10 configures the “eDRX parameter” for the idle state included in the registration accept message (stores the eDRX parameter in the storage device 12) (S303).

In addition, the core network 30 transmits, to the base station 20-A, the message (N2 message) including the “eDRX parameter” for the idle state determined in step S301 (S304).

Specifically, in order to notify the base station 20-A of information necessary for the base station 20 to communicate with the terminal 10, the core network 30 transmits an initial context setup request message to the base station 20-A. Here, in order to notify the base station 20 of the “eDRX parameter” for the idle state determined by the core network 30, the core network 30 includes the eDRX parameter for the idle state in the initial context setup request, and transmits the eDRX parameter for the idle state. Note that, the eDRX parameter for the idle state may be a part of core network assistance information for RRC inactive included in the initial context setup request. In addition to the initial context setup request message, a UE context modification request message, a handover request message, a path switch request acknowledge message, and the like are included in the N2 messages transmitted in step S304. The core network 30 may include the eDRX parameter for the idle state in the N2 message, and may transmit the eDRX parameter for the idle state to the base station 20-A. The N2 message including the eDRX parameter for the idle state is received, and thus, the base station 20-A can recognize the eDRX parameter for the idle state configured for the terminal 10.

Subsequently, communication is started between the terminal 10 and the base station 20, and an RRC message is transmitted and received as necessary. The RRC message transmitted from the terminal 10 to the base station 20 is, for example, an RRC setup request (RRCSetupRequest) message, an RRC setup completion (RRCSetupComplete) message, an RRC reconfiguration completion (RRCReconfigurationComplete) message, an RRC reestablishment request (RRCReestablishmentRequest) message, an RRC reestablishment completion (RRCReestablishmentComplete) message, an RRC resume request (RRCResumeRequest/RRCResumeRequest1) message, an RRC resume completion (RRCResume Complete) message, and the like.

Here, the terminal 10 that desires the validation of the eDRX transmits, to the base station 20, the RRC message including the “eDRX parameter” indicating the eDRX operation for the inactive state desired (requested) to be configured (S305). The terminal 10 may include the eDRX parameter in the RRC setup request message or the RRC setup completion message, and may transmit the eDRX parameter to the base station 20. Alternatively, the terminal 10 may include the eDRX parameter in the RRC reconfiguration completion message, the RRC reestablishment request message, the RRC reestablishment completion message, the RRC resume request message, the RRC resume completion message, or the like, and may transmit the eDRX parameter to the base station 20.

Note that, in a case where the “eDRX parameter” for the inactive state is included in the RRC setup completion message, the terminal 10 may include the “eDRX parameter” for the idle state in the registration request message included in the RRC setup completion message. In other words, the processing procedure of step S305 of FIG. 7 may include the processing procedure of step S300. Since it is possible to perform the transmission of the “eDRX parameter” for the idle state and the transmission of the “eDRX parameter” for the inactive state at the same timing, it is possible to simplify a processing logic of the terminal 10.

For example, it is assumed that the terminal 10 in the inactive state desires the eDRX operation in which the eDRX cycle is 2 hyperframes, the PTW is 1 second, and the number of starting positions of the PTW is 8. In this case, the terminal 10 may transmit, to the base station 20, the “eDRX parameter” for the inactive state indicating that the eDRX cycle in the inactive state is 2 hyperframes, the PTW is 2 seconds, and the number of starting positions of the PTW is 8.

In addition, in a case where the terminal 10 desires that the “eDRX parameter” for the inactive state may be the same as the “eDRX parameter” for the idle state, the terminal 10 may explicitly or implicitly include, in the RRC message, the information indicating that the “eDRX parameter” for the inactive state has the same value as the “eDRX parameter” for the idle state. For example, in a case where a case where there is information (for example, a name of an information element that stores the eDRX parameter) indicating that the “eDRX parameter” for the inactive state is requested in the RRC setup completion message but a specific eDRX parameter is not included (that is, a case where the eDRX parameter is “absent”), the information may imply that the eDRX parameter for the inactive state is the same as the eDRX parameter for the idle state.

Subsequently, the base station 20 determines the “eDRX parameter” for the inactive state configured for the terminal 10 based on the “eDRX parameter” for the inactive state received from the terminal 10 (S306). The base station 20 determines the “eDRX parameter” for the inactive state to be configured for the terminal 10 in consideration of, for example, the “eDRX parameter” received from the terminal 10, the load of the wireless network, the attribute of the terminal 10, the capability of the terminal 10, and/or the like. The base station 20 may determine the “eDRX parameter” configured for the terminal 10 to have the same value as the “eDRX parameter” desired by the terminal 10, or may determine the “eDRX parameter” to have a value different from the “eDRX parameter” desired by the terminal 10. In addition, the base station 20-A may determine the “eDRX parameters” for the inactive state while referring to the “eDRX parameter” for the idle state received from the core network 30 in step S304. For example, the base station 20-A may determine the “eDRX parameter” for the inactive state such that the PTW starting position in the inactive state is the same as the PTW starting position calculated by the “eDRX parameter” for the idle state received from the core network 30.

Subsequently, when an instruction about the transition to the inactive state is given to the terminal 10, the base station 20 transmits, to the terminal 10, an RRC release message including the determined “eDRX parameter” for the inactive state (S307). Note that, in a case where the determined “eDRX parameter” for the idle state (the “eDRX parameter” for the idle state notified from the core network 30 in step S304) and the “eDRX parameter” for the inactive state are the same, the base station 20 may explicitly or implicitly include, in the RRC release message, the information indicating that the eDRX parameter for the inactive state has the same value as the eDRX parameter for the idle state. For example, in a case where a case where there is information (for example, a name of an information element that stores the eDRX parameter) indicating that the “eDRX parameter” for the inactive state is configured in the RRC release message but a specific eDRX parameter is not included (that is, a case where the eDRX parameter is “absent”), the information may imply that the eDRX parameter for the inactive state is the same as the eDRX parameter for the idle state.

The terminal 10 configures the eDRX parameter for the inactive state included in the RRC release message (stores the eDRX parameter in the storage device 12) (S308). Note that, in a case where the information indicating that the eDRX parameter for the inactive state has the same value as the eDRX parameter for the idle state is explicitly or implicitly included in the RRC release message, the terminal 10 may recognize that the eDRX parameter for the inactive state has the same as the eDRX parameter for the idle state. In this case, the terminal 10 may configure the same value as the eDRX parameter for the idle state to the eDRX parameter for the inactive state.

Note that, when the determined eDRX parameter is configured for the terminal 10, the base station 20 may include the eDRX parameter for the inactive state in another RRC message transmitted from the base station 20 to the terminal 10 instead of the RRC release message. The other RRC message includes, for example, an RRC reconfiguration (RRCReconfiguration) message, an RRC reestablishment (RRCReestablishment) message, an RRC resume request (RRCResumeRequest/RRCResumeRequest1) message, an RRC resume (RRCResume) message, an RRC setup (RRCSetup) message, and the like.

In addition, the base station 20-A transmits, to the core network 30, the message (N2 message) including the determined “eDRX parameter” for the inactive state (S309). Specifically, the base station 20-A transmits, to the core network 30, an initial context setup response message which is a response message to the initial context setup request. Here, in order to notify the core network 30 of the “eDRX parameter” for the inactive state determined by the base station 20-A, the base stations 20-A include the eDRX parameter for the inactive state in the initial context setup response, and transmits the eDRX parameter for the inactive state. Note that, the eDRX parameter for the inactive state may be a part of core network assistance information for RRC inactive included in the initial context setup response. In addition to the initial context setup response message, a UE context modification response message, a handover request acknowledge message, a path switch request message, and the like are included in the N2 messages. The base station 20-A may include the eDRX parameter for the inactive state in these N2 message, and may transmit the eDRX parameter for the inactive state to the core network 30.

Note that, in a case where the “eDRX parameter” for the idle state received from the core network 30 and the “eDRX parameter” for the inactive state determined in step S306 described above are different, the base station 20-A may transmit, to the core network 30, the message including the “eDRX parameter” for the inactive state. For example, in the case where the starting position of the PTW calculated from the “eDRX parameter” for the idle state and the starting position of the PTW calculated from the “eDRX parameter” for the inactive state are different, for example, the base station 20-A transmits, to the core network 30, the message including the “eDRX parameter” for the inactive state.

Subsequently, in a case where the PTW starting position calculated from the “eDRX parameter” for the idle state determined in step S301 described above and the PTW starting position calculated from the “eDRX parameter” for the inactive state included in the message received from the base station 20-A, the core network 30 may modify the “eDRX parameter” for the idle state such that the PTW starting position in the idle state is the same as the PTW starting position calculated by the “eDRX parameter” for the inactive state (S310). For example, in a case where the message including the “eDRX parameter” for the inactive state is received from the base station 20-A, the core network 30 may perform modification such that the “eDRX parameter” for the idle state coincides with the “eDRX parameter” for the inactive state. In addition, for example, the core network 30 may modify the “eDRX parameter” for the idle state such that the number of starting positions of the PTW in the PH indicated by the “eDRX parameter” for the idle state is the same as the number of starting positions of the PTW in the PH indicated by the “eDRX parameter” for the inactive state in a case where the number of starting positions of the PTW in the PH indicated by the “eDRX parameter” for the idle state and the number of starting positions of the PTW in the PH indicated by the “eDRX parameter” for the inactive state are the same by setting the starting positions of the PTWs to be the same.

Subsequently, in order to configure the “eDRX parameter” for the terminal 10, the core network 30 transmits, to the terminal 10, a NAS message including the modified “eDRX parameter” for the idle state (S311). Note that, the NAS message may be a registration accept message, a service accept message, an identity request message, a notification message, or the like.

The terminal 10 modifies the “eDRX parameter” for the idle state configured in step S303 described above to the “eDRX parameter” for the idle state included in the NAS message (S312).

Thereafter, as in the description of FIG. 5, the terminal 10 monitors the control channel candidates within the paging search space with the PTW in the PH indicated by the configured eDRX parameter for the idle state or the configured eDRX parameter for the inactive state. In addition, when the paging message is transmitted, the base station 20 transmits the DCI within the paging search space with the PTW in the PH indicated by the eDRX parameter for the idle state or the eDRX parameter for the inactive state.

Note that, in the processing procedure of FIG. 7, the processing procedure of step S311 may be omitted, and the terminal 10 may modify the eDRX parameter for the idle state by itself in the processing procedure of step S312. For example, in a case where the PTW starting position calculated from the “eDRX parameter” for the idle state notified in the processing procedure of step S302 and the “eDRX parameter” for the inactive state notified in the processing procedure of step S307 are different, the terminal 10 may modify the “eDRX parameter” for the idle state such that the PTW starting positions are the same. For example, the terminal 10 may perform modification by itself such that the “eDRX parameter” for the idle state coincides with the “eDRX parameter” for the inactive state.

In the processing procedures of FIGS. 5 to 7 described above, the processing procedure related to any one of the request and configuration of the “eDRX parameter” for the idle state and the “eDRX parameter” for the inactive state may be omitted. For example, the processing procedure related to the “eDRX parameter” for the inactive state may be omitted from the processing procedures of step S100 to step S103 of FIG. 5.

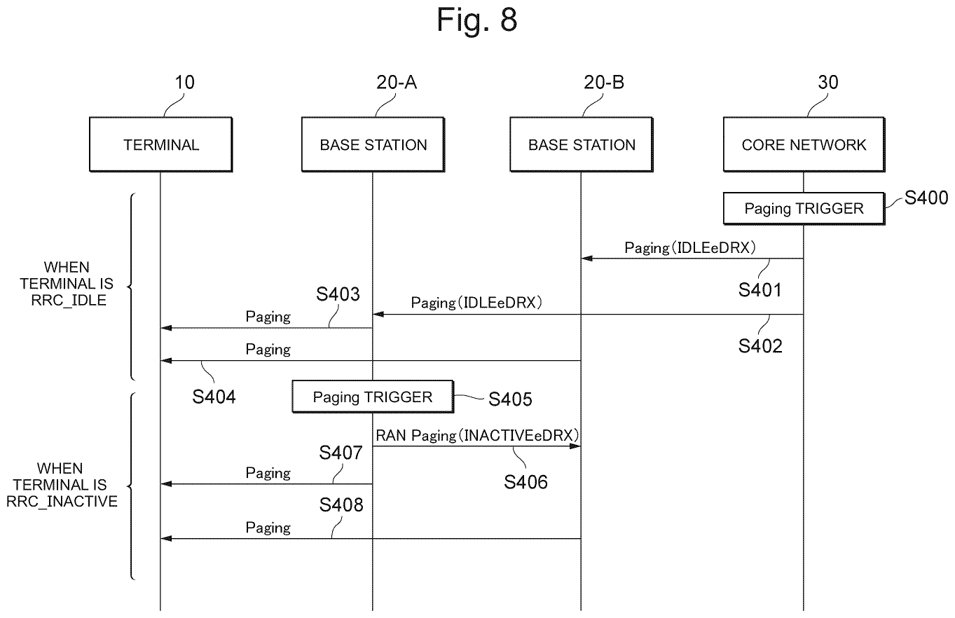

FIG. 8 is a diagram illustrating an example of a processing procedure of paging in a case where the terminal is in the idle state or the inactive state.

In a case where the terminal 10 is in the idle state, the base stations 20-A and 20-B does not preserve context storing information on the “eDRX parameter” for the idle state configured for the terminal 10.

In this case, the core network 30 notifies each base station 20 (here, it is assumed to be the base station 20-A or 20-B) in a tracking area where the terminal 10 is served of the “eDRX parameter” for the idle state determined by the core network 30. Specifically, in a case where a trigger for paging is established (S400), the core network 30 transmits the “eDRX parameter” for the idle state to the base stations 20-A and 20-B by the paging message (S401 and S402).

The base stations 20A and 20-B can recognize the “eDRX parameter” for the idle state configured for the terminal 10 by receiving the “eDRX parameter” for the idle state from the core network 30. Then, the base stations 20-A and 20-B perform paging processing for the terminal 10 based on the “eDRX parameter” for the idle state (S403 and S404). That is, the core network 30 performs the paging processing for the terminal 10 in units of the tracking area.

On the other hand, in a case where the terminal 10 is in the inactive state, of the base stations 20-A and 20-B, although the base station that last communicated with the terminal 10 (also referred to as a last serving base station (Last Serving gNB) and the base station 20-A in the example illustrated in FIG. 8) preserves the “eDRX parameter” for the inactive state configured for the terminal 10 in the context, the other base station (the base station 20-B in the example illustrated in FIG. 8) does not preserve the context of the terminal 10 and also does not certainly preserve the “eDRX parameter” for the inactive state.

In this case, in a case where the trigger for paging is established, the base station 20-A notifies the base station 20-B of the “eDRX parameter” for the inactive state. Specifically, in a case where the trigger for paging is established (S405), the base station 20-A transmits the “eDRX parameter” for the inactive state to the other base station 20-B located in the same RAN notification area as the base station 20-A by a RAN paging message by the RAN paging (S406).

The base station 20-B can recognize the “eDRX parameter” for the inactive state configured for the terminal 10 by receiving the “eDRX parameter” for the inactive state from the base station 20-A. Then, the base stations 20-A and 20-B perform the paging processing for the terminal 10 based on the “eDRX parameter” for the inactive state (S407 and S408). That is, the base stations 20-A and 20-B perform the paging processing for the terminal 10 in units of the RAN notification area.

According to the processing procedures described above, the core network 30 can determine the eDRX parameter for the idle state and the eDRX parameter for the inactive state, and may notify the terminal 10 of the determined the eDRX parameters. In addition, the terminal 10 that desires the validation of the eDRX can request the base station 20 or the core network 30 to notify (configure) the eDRX parameter for the idle state and to notify (configure) the eDRX parameter for the inactive state. In addition, in the processing procedures described above, in a case where the eDRX parameter for the inactive state is the same as the eDRX parameter for the idle state, for example, the eDRX parameter for the inactive state is omitted. Accordingly, it is possible to reduce the amount of data of the NAS message, the N2 message, and/or the RRC message. Specification modification example

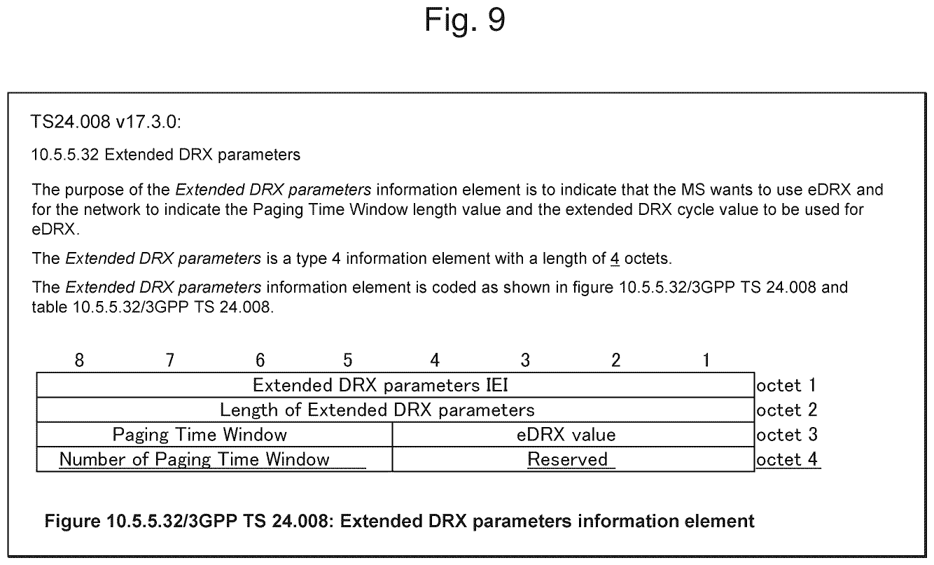

FIGS. 9 to 25 are diagrams illustrating a specification modification example of the 3GPP specification. Underlined portions in FIGS. 9 to 25 illustrate specifications of information elements for storing fields indicating the eDRX parameters and values configured in the fields indicating the eDRX parameters.

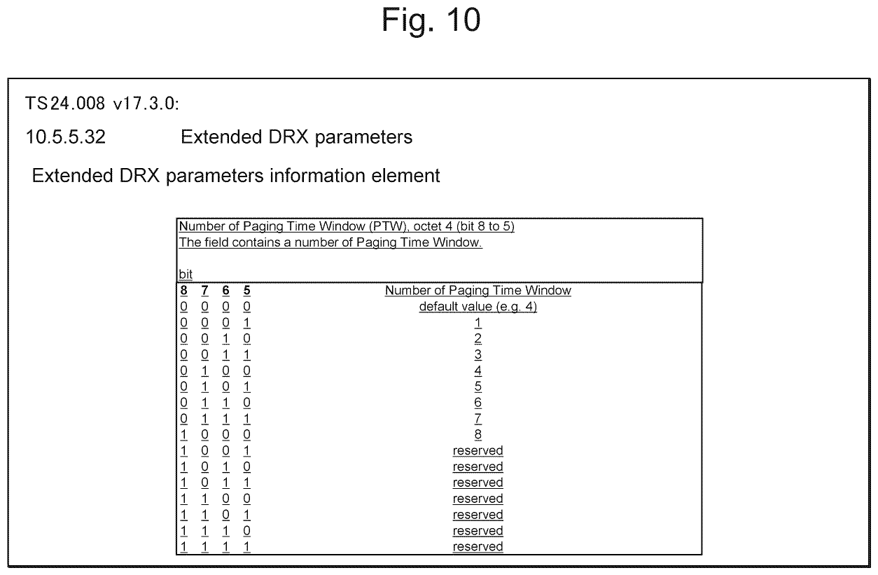

FIG. 9 illustrates a specification modification example of the “eDRX parameters” included in the registration request and registration accept messages. As illustrated in FIG. 9, a region for storing the “eDRX parameter” has regions of 4 octets, and “Paging Time Window”, “eDRX value”, and “Number of Paging Time Window” are stored in 2 octets out of 4 octets (more specifically, the regions of the third octet and the fourth octet). In addition, the “Number of Paging Time Window” is stored in the region of the fourth octet. The “Number of Paging Time Window” of FIG. 9 corresponds to the number of starting positions of the PTW in the PH. In addition, the “eDRX value” corresponds to the eDRX cycle. FIG. 10 corresponds to a specific example of the “Number of Paging Time Window”.

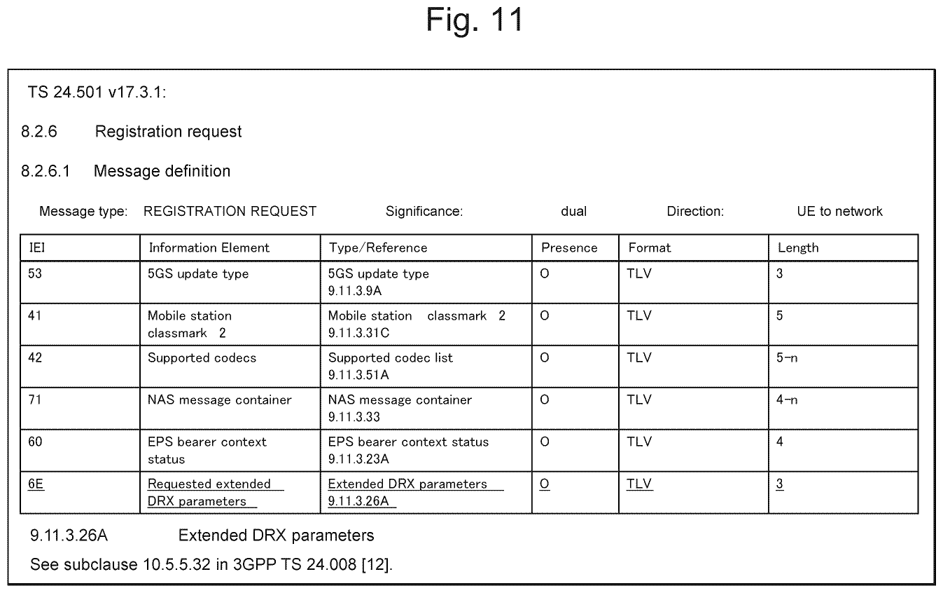

FIG. 11 illustrates a specification definition example related to Requested extended DRX Parameters which are the configuration information regarding the eDRX, as an example of the information transmitted by the registration request message described in the processing procedures of step S100 of FIG. 5, step S200 of FIG. 6, and step S300 of FIG. 7. Specifically, the eDRX parameters illustrated in FIG. 9 are stored in the Requested extended DRX Parameters.

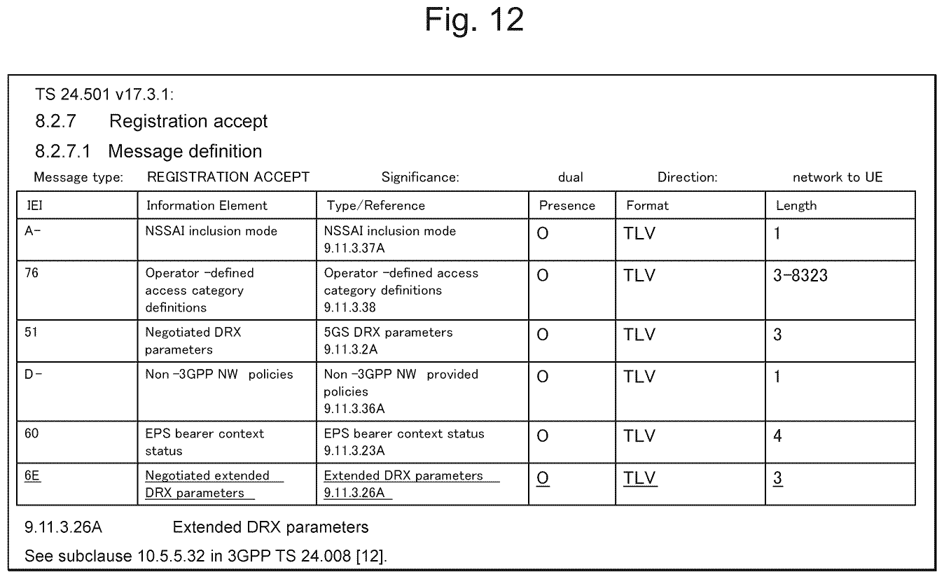

FIG. 12 illustrates a specification definition example related to negotiated extended DRX parameters which are the configuration information regarding the eDRX, as an example of the information transmitted by the registration accept message described in the processing procedures of step S102 of FIG. 5, step S202 of FIG. 6, and step S302 of FIG. 7. Specifically, the eDRX parameters illustrated in FIG. 9 are stored in the negotiated extended DRX parameters.

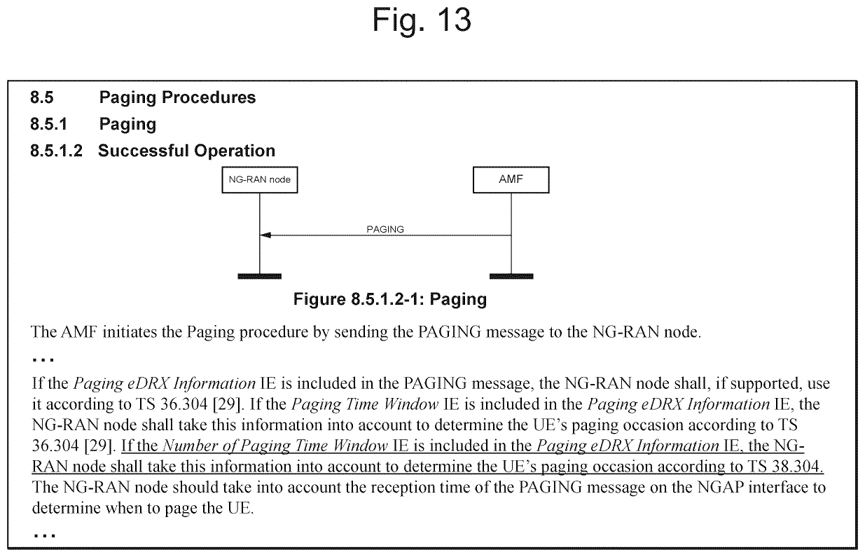

Underlined portions of FIG. 13 illustrate a content of the paging message described in the processing procedures of step S401 and step S402 of FIG. 8, and a specification modification example related to an operation of the base station 20 described in the processing procedures of step S403 and step S404.

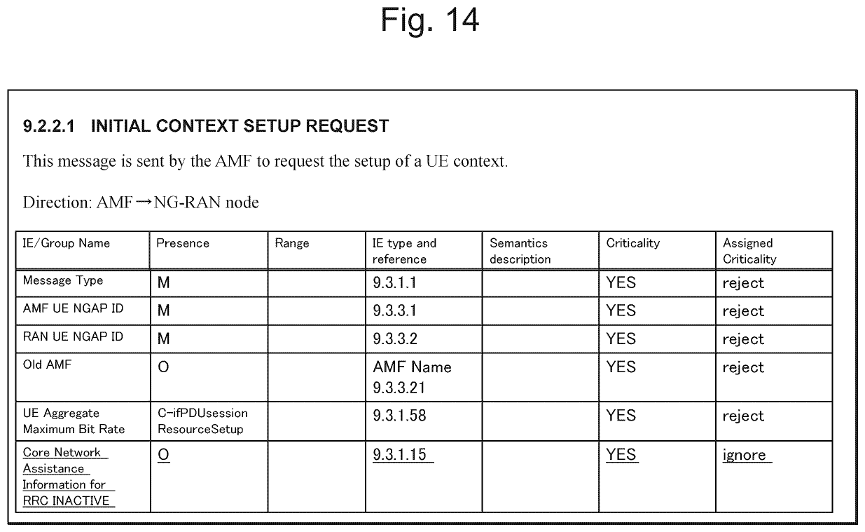

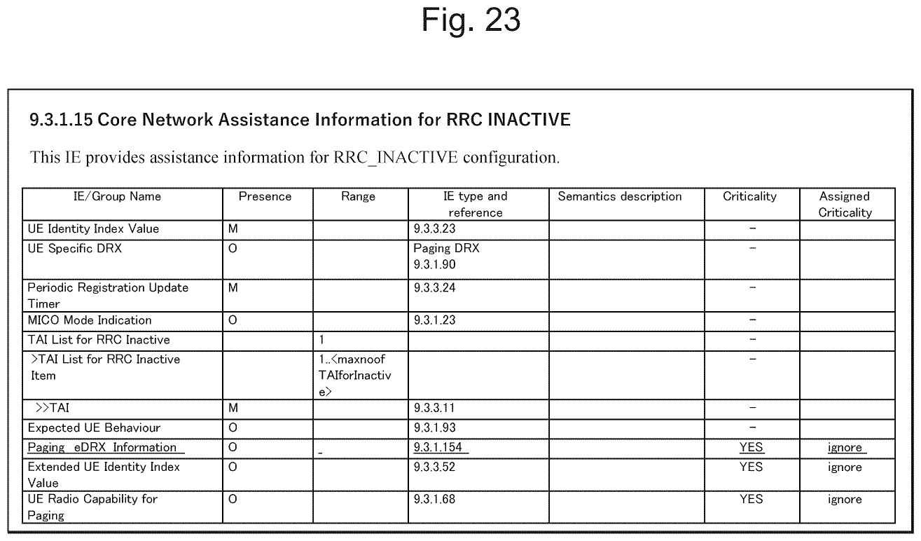

FIG. 14 illustrates a specification definition example related to the core network assistance information for RRC inactive which is the configuration information regarding the eDRX, as an example of the information transmitted by the initial context setup request message described in the processing procedures of step S202 of FIG. 6 and step S304 of FIG. 7. The eDRX parameters illustrated in FIGS. 23 to 25 to be described later are stored in the core network assistance information for RRC inactive.

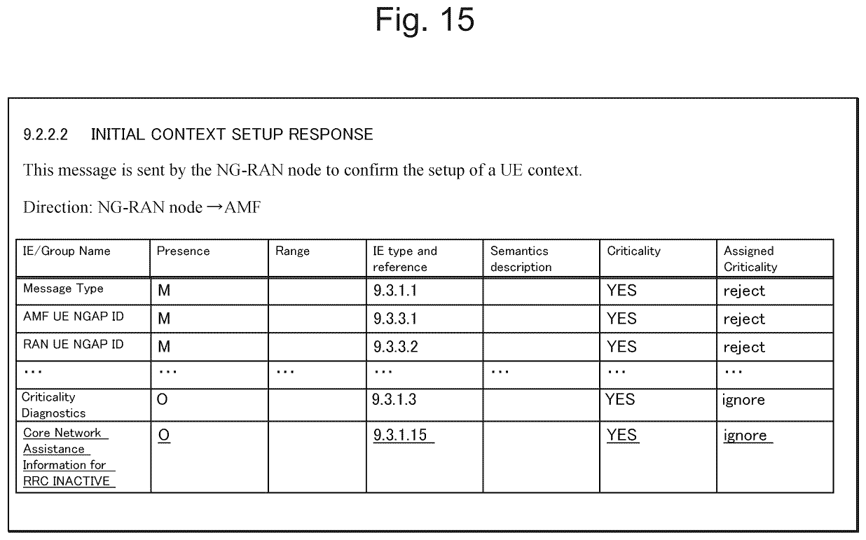

FIG. 15 illustrates a specification modification example in a case where the core network assistance information for RRC inactive which is the configuration information regarding the eDRX is added to the initial context setup response message described in the processing procedures of step S204 of FIG. 6 and step S309 of FIG. 7.

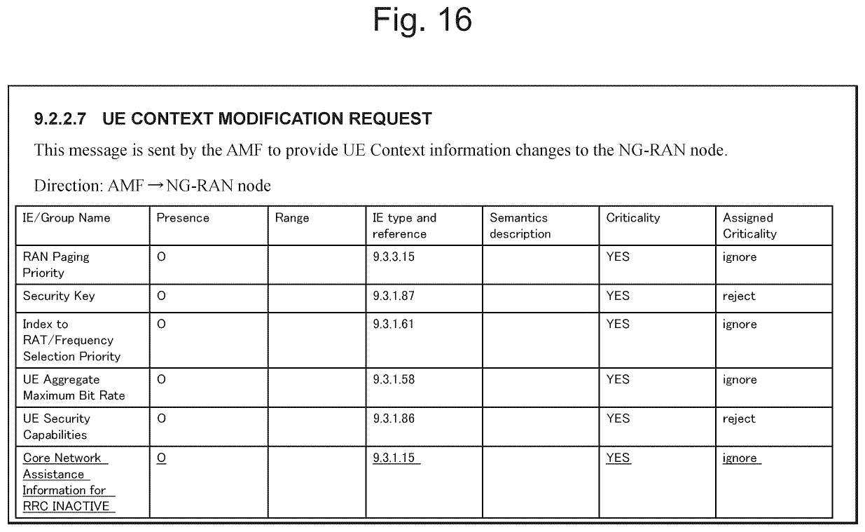

FIG. 16 illustrates a specification modification example related to the core network assistance information for RRC inactive which is the configuration information regarding the eDRX, as an example of the information transmitted by the UE context modification request message described in the processing procedures of step S202 of FIG. 6 and step S304 of FIG. 7.

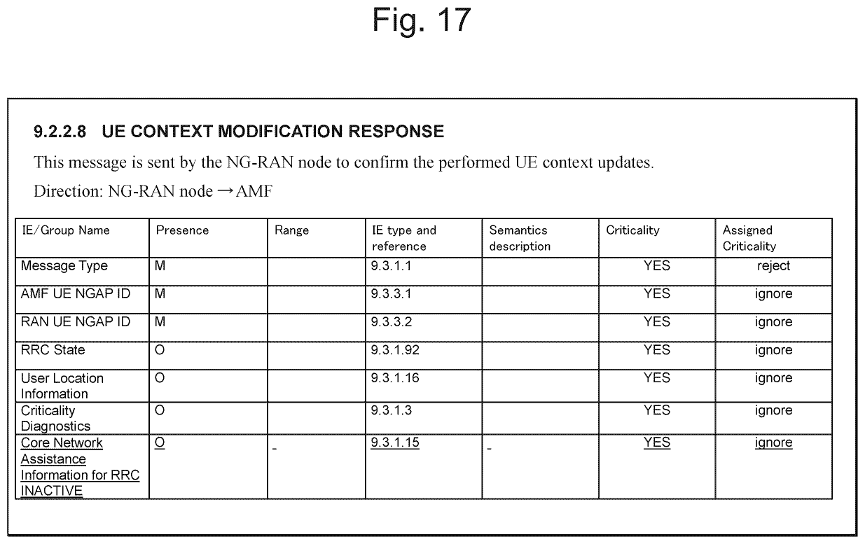

FIG. 17 illustrates a specification modification example in a case where the core network assistance information for RRC inactive which is the configuration information regarding the eDRX to the UE context modification response message described in the processing procedures of step S204 of FIG. 6 and step S309 of FIG. 7.

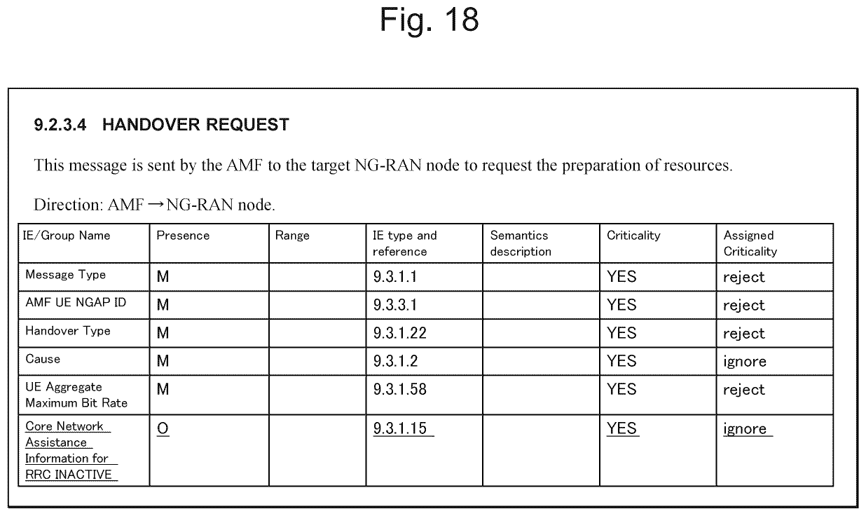

FIG. 18 is a specification definition example related to the core network assistance information for RRC inactive which is the configuration information regarding the eDRX, as an example of the information transmitted by the handover request message described in the processing procedures of step S202 of FIG. 6 and step S304 of FIG. 7.

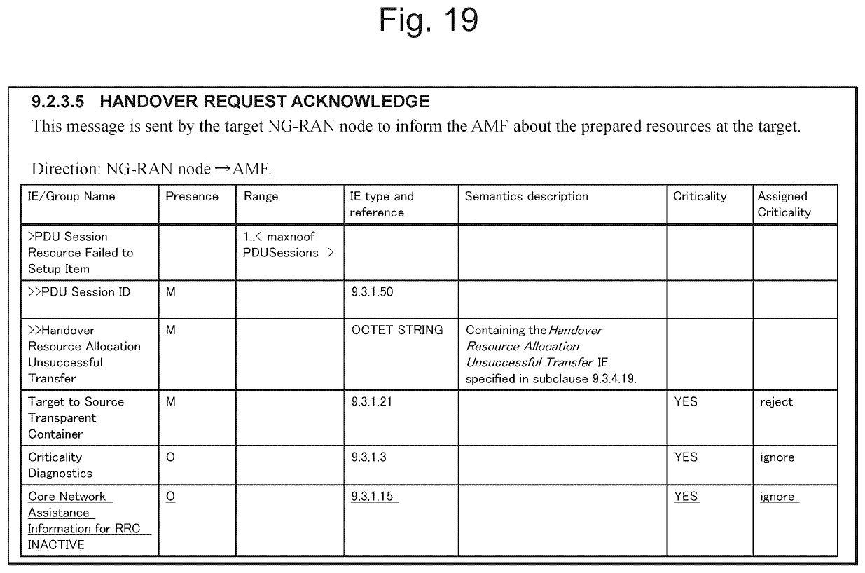

FIG. 19 is a specification modification example in a case where the core network assistance information for RRC inactive which is the configuration information regarding the eDRX is added to the handover request acknowledge message described in the processing procedures of step S204 of FIG. 6 and step S309 of FIG. 7.

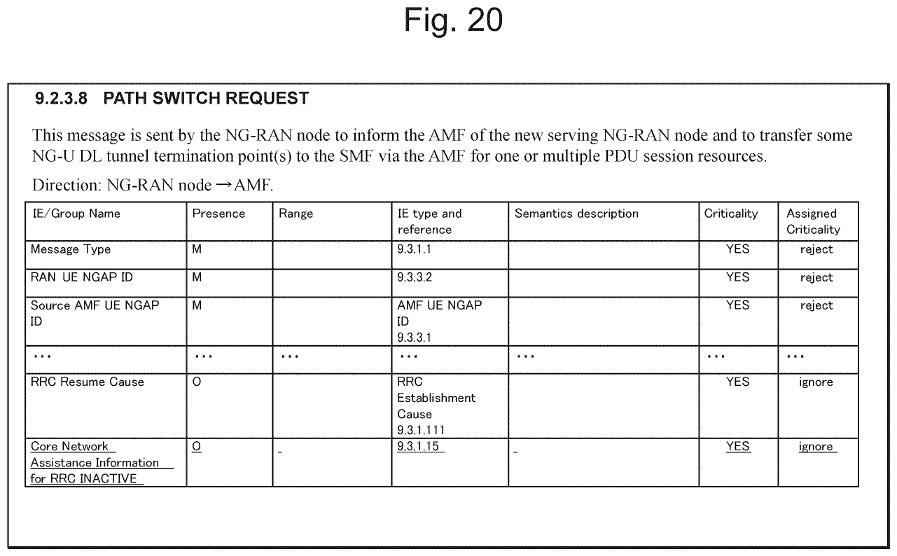

FIG. 20 illustrates a specification modification example in a case where the core network assistance information for RRC inactive which is the configuration information regarding the eDRX is added to the path switch request message described in the processing procedures of step S204 of FIG. 6 and step S309 of FIG. 7.

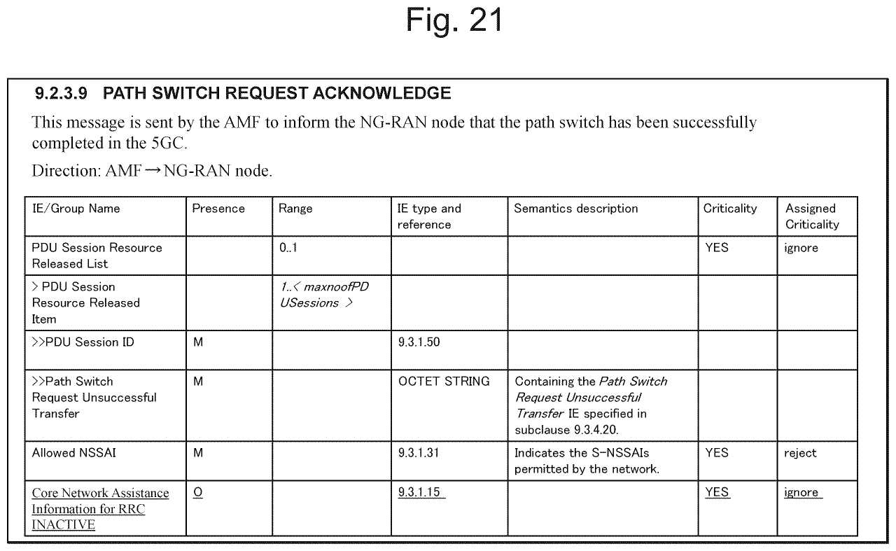

FIG. 21 illustrates a specification definition example related to the core network assistance information for RRC inactive which is the configuration information regarding the eDRX, as an example of the information transmitted by the path switch request acknowledge message described in the processing procedures of step S202 of FIG. 6 and step S304 of FIG. 7.

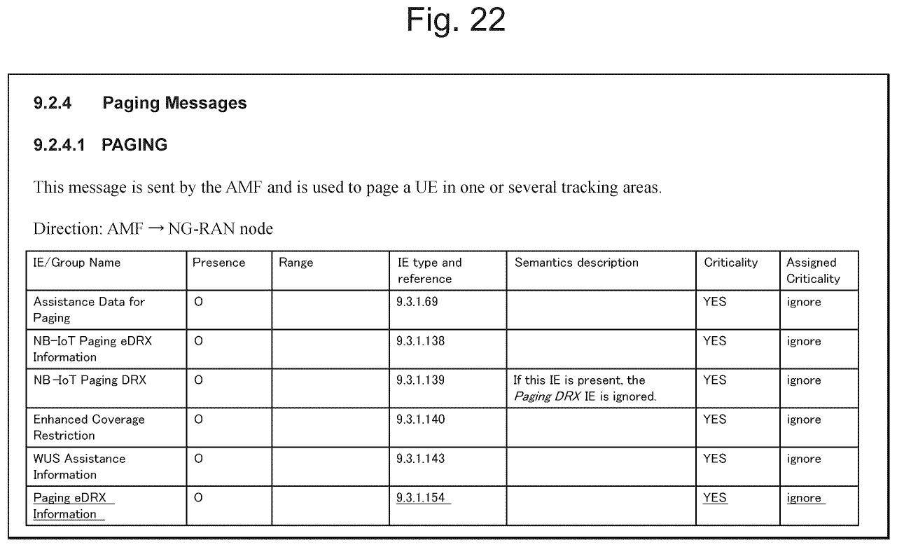

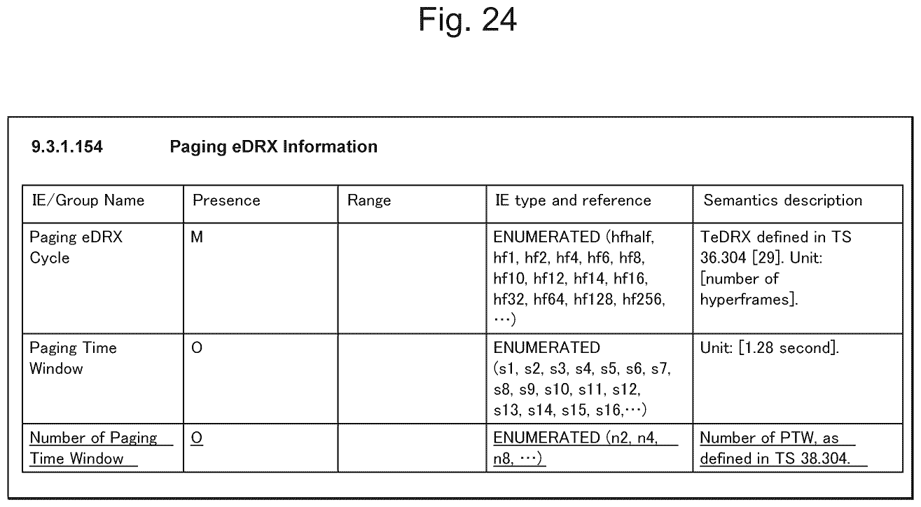

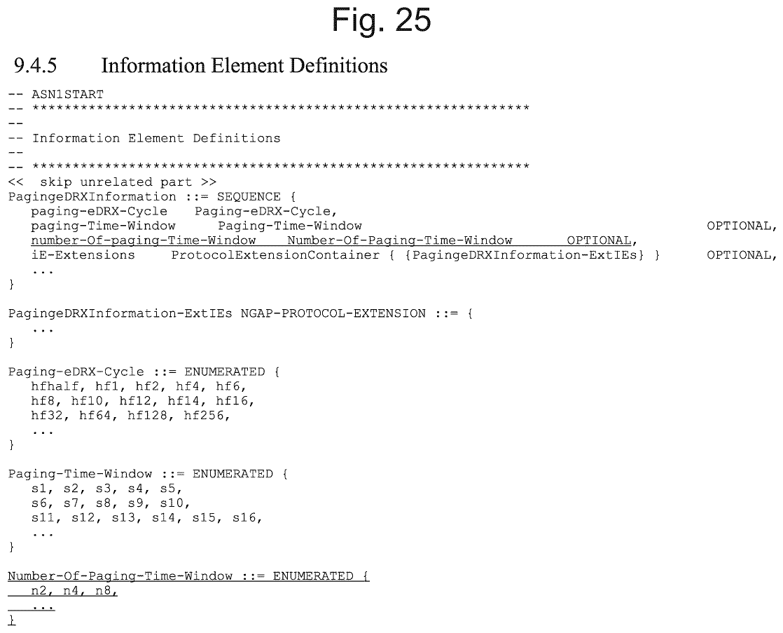

FIG. 22 illustrates a specification definition example related to paging eDRX information which is the configuration information regarding the eDRX, as an example of the information transmitted by the paging message described in the processing procedures of step S401 and step S402 of FIG. 8. The eDRX parameters illustrated in FIGS. 24 and 25 to be described later are stored in the paging eDRX information.

FIG. 23 illustrates a specification definition example of the core network assistance information for RRC inactive described in FIGS. 14 to 21. A format of the paging eDRX information is illustrated in FIGS. 24 and 25 to be described later.

FIG. 24 illustrates a specification modification example of the information (paging eDRX information) regarding the eDRX parameter which is included in the paging message described with reference to FIG. 22.

FIG. 25 illustrates a format modification example of the paging eDRX information illustrated in FIG. 23. The “Number of Paging Time Window” corresponds to the number of starting positions of the PTW in the PH.

### Hardware Configuration

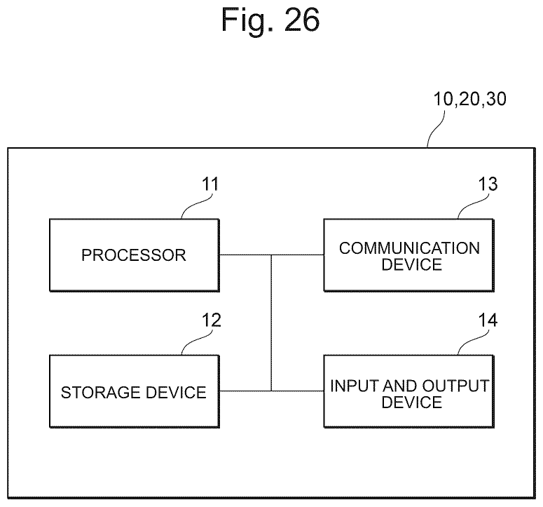

FIG. 26 is a diagram illustrating an example of a hardware configuration of each device in the wireless communication system. Each device (for example, the terminal 10, the base station 20, the core network 30, or the like) in the wireless communication system 1 includes a processor 11, the storage device 12, a communication device 13 that performs wired or wireless communication, and an input and output device 14 that includes an input device that accepts various input operations, and an output device that outputs various kinds of information.

The processor 11 is, for example, a central processing unit (CPU), and controls each device in the wireless communication system 1. The processor 11 may perform various kinds of processing described in the present embodiment by reading the program from the storage device 12 and executing the program. Each device in the wireless communication system 1 may include one or more processors 11. In addition, each device may be called a computer.

The storage device 12 includes, for example, a memory, a hard disk drive (HDD), and/or a storage such as a solid state drive (SSD). The storage device 12 may store various kinds of information (for example, a program executed by the processor 11 or the like) necessary for performing processing by the processor 11.

The communication device 13 is a device that communicates via a wired and/or wireless network, and may include, for example, a network card, a communication module, a chip, an antenna, and the like. In addition, the communication device 13 may include an amplifier, a radio frequency (RF) device that performs processing related to a wireless signal, and a baseband (BB) device that performs baseband signal processing.

For example, the RF device generates a wireless signal transmitted from the antenna by performing D/A conversion, modulation, frequency conversion, power amplification, or the like on a digital baseband signal received from the BB device. In addition, the RF device generates a digital baseband signal by performing frequency conversion, demodulation, A/D conversion, or the like on the wireless signal received from the antenna, and transmits the digital baseband signal to the BB device. The BB device performs processing of converting a digital baseband signal into a packet and processing of converting a packet into a digital baseband signal.

The input and output device 14 includes, for example, an input device such as a keyboard, a touch panel, a mouse and/or a microphone, and, for example, an output device such as a display and/or a speaker.

The hardware configuration described above is merely an example. Each device in the wireless communication system 1 may not include some hardware that is illustrated in FIG. 26 or may include hardware that is not illustrated in FIG. 26. In addition, the hardware illustrated in FIG. 26 may include one or more chips.

### Functional Configuration

### Terminal

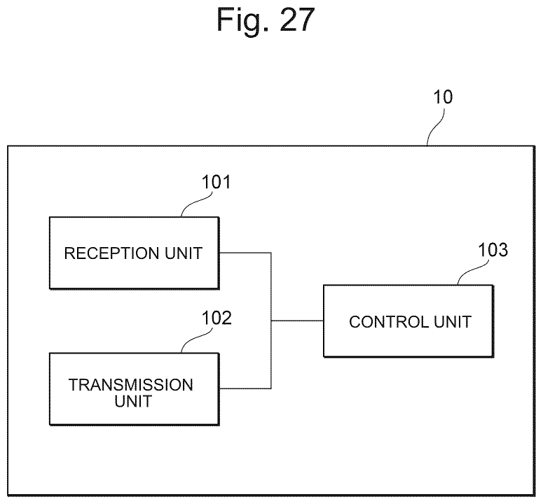

FIG. 27 is a diagram illustrating an example of a functional configuration of

the terminal 10. The terminal 10 includes a reception unit 101, a transmission unit 102, and a control unit 103. All or part of functions realized by the reception unit 101 and the transmission unit 102 can be realized by using the communication device 13. In addition, all or part of the functions realized by the reception unit 101 and the transmission unit 102, and the control unit 103 can be realized by the processor 11 executing the program stored in the storage device 12. In addition, the program can be stored in a storage medium. The storage medium in which the program is stored may be a non-transitory computer readable medium. The non-transitory storage medium is not particularly limited, but may be, for example, a storage medium such as a USB memory, a CD-ROM, or the like.

In the following description, the eDRX parameter is an example of an eDRX configuration value. In addition, an information element (for example, the negotiated extended DRX parameters, the core network assistance information for RRC inactive, the paging eDRX information, or the like) of the RRC message, the N2 message, or the NAS message including the eDRX parameter for the idle state, the RRC message, the N2 message, and/or the NAS message are examples of first configuration information. The first configuration information may be referred to as the configuration information. In addition, the information element (for example, RAN-PagingExtendedDRX-Info, the negotiated extended DRX parameters, the core network assistance information for RRC inactive, the paging eDRX information, or the like) of the RRC message, the N2 message, or the NAS message including the eDRX parameter for the inactive state, the RRC message, the N2 message, and/or the NAS message are examples of second configuration information. In addition, the information element (for example, the requested extended DRX parameters or the like) of the RRC message, the N2 message, or the NAS message including the eDRX parameters for the inactive state and/or the idle state desired (requested) to be configured by the terminal 10, the RRC message, the N2 message, and/or the NAS message are examples of a configuration request.

The reception unit 101 receives a downlink signal. In addition, the reception unit 101 may receive information and/or data transferred via the downlink signal. Here, a case where “the reception unit may receive information and/or data” may include, for example, a case where processing related to reception such as at least one of reception of a wireless signal, demapping, demodulation, decoding, monitoring, and measurement is performed.

The reception unit 101 receives the first configuration information including the eDRX configuration value for the RRC idle state, which is configured in response to the configuration request transmitted from the transmission unit 102, and the eDRX configuration value includes information indicating the number of starting positions of a reception period in a given H-SFN. The PH indicated by the eDRX configuration value is, for example, an example of the given H-SFN. The PTW is, for example, an example of the reception period. The registration request message may be, for example, an example of the configuration request.

The reception unit 101 receives the second configuration information including the eDRX configuration value for the RRC inactive state, and the eDRX configuration value includes the information indicating the number of starting positions of the reception period in the given H-SFN, which is determined in response to the configuration request transmitted from the transmission unit 102.

The reception unit 101 may receive the NAS message including the first configuration information and/or the second configuration information from the core network 30. The registration accept message is an example of the NAS message.

The reception unit 101 may receive the NAS message including the first configuration information from the core network 30, and may receive the RRC message including the second configuration information from the base station 20.

A starting position of the reception period may be determined by inputting information indicating the number of starting positions of the reception period in the given H-SFN to given calculation formulas. Formulas 2, 3, 4, and 5 described above are examples of the given calculation formulas.

The first configuration information may have regions of 4 octets, and the eDRX configuration value may be stored in regions of 2 octets out of 4 octets.

The second configuration information may have regions of 4 octets, and the eDRX configuration value may be stored in regions of 2 octets out of 4 octets.

The transmission unit 102 transmits an uplink signal. In addition, the transmission unit 102 may transmit information and/or data transferred via the uplink signal. Here, a case where “the transmission unit may transmit the information and/or data” may include, for example, a case where processing related to transmission such as at least one of encoding, modulation, mapping, and transmission of a wireless signal.

The transmission unit 102 transmits the configuration request requesting the configuration of the eDRX configuration value for the RRC idle state, and the eDRX configuration value includes the information indicating the number of starting positions of the reception period in the given H-SFN.

The transmission unit 102 transmits the configuration request including the eDRX configuration value for the RRC inactive state, and the eDRX configuration value includes the information indicating the number of starting positions of the reception period in the given H-SFN.

The control unit 103 performs various kinds of processing related to the eDRX based on the eDRX configuration value received by the reception unit 101. In addition, in the RRC idle state, the control unit 103 performs control such that the control channel candidates (PDCCH candidates) within the paging search space are monitored in the reception period in the given H-SFN indicated by the eDRX configuration value for the RRC idle state.

In addition, in the RRC inactive state, the control unit 103 performs control such that the control channel candidates within the paging search space are monitored in the reception period in the given H-SFN indicated by the eDRX configuration value for the RRC inactive state.

In the RRC idle state, the control unit 103 performs control such that the number of starting positions of the reception period in the given H-SFN coincides with the number indicated by the first configuration information received by the reception unit 101 (the number of starting position of the reception period indicated by the first configuration information) to perform the eDRX. That is, the control unit 103 recognizes that the number indicated by the first configuration information is the number of starting positions of the reception period in the given H-SFN applied to eDRX processing for the RRC idle state, and performs the eDRX processing.

In the RRC inactive state, the control unit 103 performs control such that the number of starting positions of the reception period in the given H-SFN coincides with the number indicated by the second configuration information received by the reception unit 101 (the number of starting positions of the reception period indicated by the second configuration information) to perform the eDRX. That is, the control unit 103 recognizes that the number indicated by the second configuration information is the number of starting positions of the reception period in the given H-SFN applied to eDRX processing for the RRC inactive state, and performs the eDRX processing.

In a case where the starting position of the reception period in the given H-SFN indicated by the first configuration information received by the reception unit 101 and the starting position of the reception period in the given H-SFN indicated by the second configuration information received by the reception unit 101 are different, the control unit 103 may modify the eDRX configuration value such that the starting position of the reception period in the given H-SFN indicated by the first configuration information is the same as the starting position of the reception period in the given H-SFN indicated by the second configuration information.

### Base Station

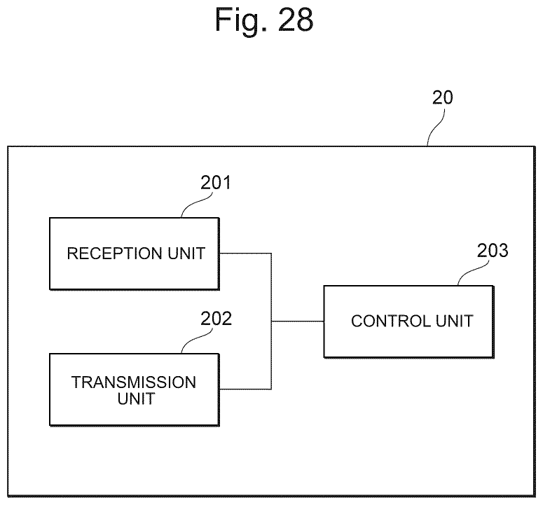

FIG. 28 is a diagram illustrating an example of a functional configuration of the base station 20. The base station 20 includes a reception unit 201, a transmission unit 202, and a control unit 203. All or part of functions realized by the reception unit 201 and the transmission unit 202 can be realized by using the communication device 13. In addition, all or part of the functions realized by the reception unit 201 and the transmission unit 202, and the control unit 103 can be realized by the processor 11 executing the program stored in the storage device 12. In addition, the program can be stored in a storage medium. The storage medium in which the program is stored may be a non-transitory computer readable storage medium. The non-transitory storage medium is not particularly limited, but may be, for example, a storage medium such as a USB memory, a CD-ROM, or the like.

The reception unit 201 receives an uplink signal. In addition, the reception unit 201 may receive information and/or data transferred via the uplink signal. In addition, the reception unit 201 receives request information including the eDRX configuration value for the RRC inactive state from the terminal 10.

The reception unit 201 receives the first configuration information including the eDRX configuration value the eDRX configuration value for the RRC idle state, and the eDRX configuration value including the information indicating the number of starting positions of the reception period in the given H-SFN.

The transmission unit 202 transmits a downlink signal. In addition, the transmission unit 202 may transmit information and/or data transferred via the downlink signal. In addition, the transmission unit 202 transmits the first configuration information including the eDRX configuration value for the RRC idle state to the terminal 10. In addition, the transmission unit 202 transmits, to the terminal 10, the second configuration information including the eDRX configuration value applied to the terminal 10 in the RRC inactive state.

The transmission unit 202 transmits, to the core network 30 or the terminal 10, the second configuration information including the eDRX configuration value for the RRC inactive state, and the eDRX configuration value includes the information indicating the number of starting positions of the reception period in the given H-SFN based on the first configuration information received by the reception unit 201.

The control unit 203 controls the paging processing for the terminal 10 in the RRC idle state or the RRC inactive state. In addition, the control unit 203 performs control such that the downlink control information (for example, DCI) is transmitted to the terminal 10 in the RRC idle state within the paging search space with the PTW (reception period) in the PH (given H-SFN) indicated by the eDRX configuration value included in the first configuration information. In addition, the control unit 203 performs control such that the downlink control information (for example, DCI) is transmitted to the terminal 10 in the RRC inactive state within the paging search space with the PTW (reception period) in the PH (given H-SFN) indicated by the eDRX configuration value included in the second configuration information.

The control unit 203 performs control such that the number of starting positions of the reception period in the given H-SFN coincides with the number indicated by the second configuration information to transmit the downlink control information to the terminal 10 in the RRC inactive state in the reception period in the given H-SFN. That is, the control unit 203 recognizes that the number indicated by the second configuration information is the number of starting positions of the reception period in the given H-SFN applied to the eDRX processing for the RRC inactive state, and performs the paging processing.

### Core Network

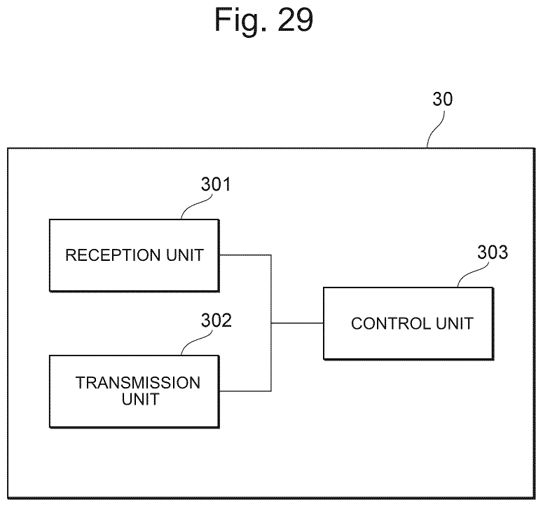

FIG. 29 is a diagram illustrating an example of a functional configuration of the core network 30. The core network 30 includes a reception unit 301, a transmission unit 302, and a control unit 303. All or part of functions realized by the reception unit 301 and the transmission unit 302 can be realized by using the communication device 13. In addition, all or part of the functions realized by the reception unit 301 and the transmission unit 302, and the control unit 303 can be realized by the processor 11 executing the program stored in the storage device 12. In addition, the program can be stored in a storage medium. The storage medium in which the program is stored may be a non-transitory computer readable storage medium. The non-transitory storage medium is not particularly limited, but may be, for example, a storage medium such as a USB memory, a CD-ROM, or the like.

The reception unit 301 receives an uplink signal. In addition, the reception unit 301 may receive information and/or data transferred via the uplink signal. In addition, the reception unit 301 receives, from the terminal 10, request information including the eDRX configuration value for the RRC idle state or the request information including the eDRX configuration value for the RRC inactive state.

The reception unit 301 receives, from the terminal 10, the configuration request requesting the configuration of the eDRX configuration value for the RRC idle state and/or the eDRX configuration value for the RRC inactive state, and the eDRX configuration value includes the information indicating the number of starting positions of the reception period in the given H-SFN. The registration request message is an example of the configuration request.

The transmission unit 302 transmits a downlink signal. In addition, the transmission unit 302 may transmit information and/or data transferred via the downlink signal. In addition, the transmission unit 302 transmits, to the terminal 10, the first configuration information including the eDRX configuration value for the RRC idle state, and the eDRX configuration value includes the information indicating the number of starting positions of the reception period in the given H-SFN. In addition, the transmission unit 302 transmits, to the terminal 10, the second configuration information including the eDRX configuration value for the RRC inactive state, and the eDRX configuration value includes the information indicating the number of starting positions of the reception period in the given H-SFN.

The transmission unit 302 transmits, to the terminal 10, the first configuration information including the eDRX configuration value for the RRC idle state, and the eDRX configuration value includes the information indicating the number of starting positions of the reception period in the given H-SFN in response to the configuration request received by the reception unit 301.

The transmission unit 302 transmits, to the terminal 10, the second configuration information including the eDRX configuration value for the RRC inactive state, and the eDRX configuration value includes the information indicating the number of starting positions of the reception period in the given H-SFN in response to the configuration request received by the reception unit 301.

The transmission unit 302 transmits, to the base station 20, the paging message including the eDRX configuration value for the RRC idle state, and the eDRX configuration value includes the information indicating the number of starting positions of the reception period in the given H-SFN.

The control unit 303 controls the paging processing for the terminal 10 in the RRC idle state or the RRC inactive state.

### Supplement

The eDRX parameter, the information element including the eDRX parameter, the RRC message including the eDRX parameter, and/or the NAS message including the eDRX parameter are examples of the configuration information of the eDRX.

A case where the information indicating that the eDRX parameter for the inactive state has the same value of the eDRX parameter for the idle state is explicitly or implicitly included may mean, for example, that a specific character string or a number such as NULL or “absent” is included in each eDRX parameter for the inactive state. In addition, the information indicating that the eDRX parameter for the inactive state has the same value as the eDRX parameter for the idle state may be configured for each eDRX parameter. For example, in a case where the time lengths of the PTWs are the same but the eDRX cycles and the numbers of starting positions of the PTWs are different, the information indicating that the eDRX parameter for the inactive state has the same value as the eDRX parameter for the idle state may be configured for the time length of the PTW.

The information indicating that the eDRX parameter for the inactive state has the same value as the eDRX parameter for the idle state may be replaced with the information indicating that the eDRX parameter for the idle state has the same value as the eDRX parameter for the inactive state. That is, in the processing procedures illustrated in FIGS. 5 to 7, in a case where “the information indicating that the eDRX parameter for the idle state has the same value as the eDRX parameter for the inactive state” is configured for the eDRX parameter for the idle state, the terminal 10, the base station 20, and the core network 30 may recognize that the eDRX parameter for the idle state is the same as the “eDRX parameter for the inactive state. In addition, the information indicating that the eDRX parameter for the idle state has the same value as the eDRX parameter for the inactive state may be configured for each eDRX parameter.

A case where “the control channel candidates within the paging search space are monitored” may be expressed as a case where “control channel candidates within a search space set configured by paging search space information (pagingSearchSpace) are monitored”.

In the above embodiment, an example of a first time unit may be set to 1 hyperframe (10.24 sec), an example of a second time unit may be set to 1 radio frame (10 ms), and an example of a third time unit may be set to 1 subframe (1 ms). In addition, the second time unit may be defined as a time shorter than the first time unit, and the third time unit may be defined as a time shorter than the second time unit. In addition, an example of a number indicating a location of the second time unit that is periodically repeated may be SFN, and an example of a number indicating a location of the first time unit that is periodically repeated may be H-SFN. For example, the H-SFN may be expressed as a first time interval of a location indicated by a given number in the first time interval that is periodically repeated. In addition, the PH may be configured in a plurality of hyperframes among the H-SFNs from 0 to 1023.

The various signals, pieces of information, and parameters in the above embodiment may be signaled at any layer. That is, the various signals, pieces of information, and parameters described above are replaced with signals, pieces of information, and parameters of any layer of a higher layer (for example, a NAS layer, an RRC layer, a MAC layer, or the like) and a lower layer (for example, a physical layer). In addition, the notification of the given information is not limited to be explicitly performed, and may be implicitly performed (for example, by not performing the information or using another information).

In addition, names of various signals, pieces of information, parameters, IEs, channels, time units, and frequency units in the above embodiment are merely examples, and may be replaced with other names. For example, a slot may have any name as long as the slot is a time unit having a given number of symbols. In addition, RB may have any name as long as the RB is a frequency unit having a given number of subcarriers (RBs). In addition, the registration accept message may be referred to as a registration approval message.

In addition, the use of the terminal 10 in the above embodiment (for example, for RedCap, IOT, or the like) is not limited to the examples, and any use (for example, eMBB, URLLC, Device-to-Device (D2D), Vehicle-to-Everything (V2X), or the like) may be used as long as the terminal has a similar function.

In addition, formats of various kinds of information are not limited to the above embodiment, and may be appropriately modified such as a bit representation (0 or 1), a truth value (Boolean: true or false), an integer value, a character, or the like. In addition, the singular and plural numbers in the above embodiment may be modified from each other.

The present embodiment has been described above with reference to specific examples. However, the present disclosure is not limited to these specific examples. Examples obtained by appropriately modifying these specific examples by a person skilled in the art are also included in the scope of the present disclosure as long as these examples have the features of the present disclosure. Each element included in each of the above-described specific examples, and the disposition, condition, and shape thereof, or the like are not limited to those exemplified, and can be appropriately modified. The combination of the elements included in each of the above-described specific examples can be appropriately modified as long as technical inconsistency does not occur.

1. A base station comprising:
transmitting circuitry configured to transmit, to a terminal, a radio resource control (RRC) release message including information indicating an extended Discontinuous Reception (eDRX) cycle for an RRC inactive state and information indicating a length of a paging time window (PTW) for the RRC inactive state; and
control circuitry configured to transmit, to the terminal in the RRC inactive state, downlink control information on a physical downlink control channel in a paging occasion in a period of the PTW,
wherein a hyper-system frame number (H-SFN) of a paging hyperframe (PH) is determined based on the information indicating the eDRX cycle,
an ending position of the PTW in the PH is determined based on the information indicating the length of the PTW, and
the transmitting circuitry is configured to notify a core network device of the eDRX cycle for the RRC inactive state and the length of the PTW for the RRC inactive state.

2. The base station according to claim 1, wherein the eDRX cycle for the RRC inactive state and the length of the PTW for the RRC inactive state are included in an N2 message.

3. The base station according to claim 1, wherein the transmitting circuitry is configured to notify another base station of the eDRX cycle for the RRC inactive state and the length of the PTW for the RRC inactive state.

4. The base station according to claim 1,
wherein the information indicating the eDRX cycle for the RRC inactive state is first information,
the information indicating the length of the PTW for the RRC inactive state is second information,
the PTW is a first PTW,
a Non Access Stratum (NAS) message including third information indicating the eDRX cycle and fourth information indicating the length of the PTW is transmitted from the core network device, and
the control circuitry is configured to transmit, to the terminal in an RRC idle state, downlink control information on a physical downlink control channel in a paging occasion in a period of a second PTW determined based on the third information and the fourth information.

5. The base station according to claim 1, wherein the core network device is an access and mobility management function (AMF).

6. A method for a base station, comprising:
transmitting, to a terminal, a radio resource control (RRC) release message including information indicating an extended Discontinuous Reception (eDRX) cycle for an RRC inactive state and information indicating a length of a paging time window (PTW) for the RRC inactive state;
transmitting, to the terminal in the RRC inactive state, downlink control information on a physical downlink control channel in a paging occasion in a period of the PTW;
determining a hyper-system frame number (H-SFN) of a paging hyperframe (PH) based on the information indicating the eDRX cycle;
determining an ending position of the PTW in the PH based on the information indicating the length of the PTW; and
notifying a core network device of the eDRX cycle for the RRC inactive state and the length of the PTW for the RRC inactive state.

7. The method according to claim 6, wherein the eDRX cycle for the RRC inactive state and the length of the PTW for the RRC inactive state are included in an N2 message.

8. The method according to claim 6, further comprising:
notifying another base station of the eDRX cycle for the RRC inactive state and the length of the PTW for the RRC inactive state.

9. The method according to claim 6,
wherein the information indicating the eDRX cycle for the RRC inactive state is first information,
the information indicating the length of the PTW for the RRC inactive state is second information,
the PTW is a first PTW,
a Non Access Stratum (NAS) message including third information indicating the eDRX cycle and fourth information indicating the length of the PTW is transmitted from the core network device, and
downlink control information is transmitted to the terminal in an RRC idle state on a physical downlink control channel in a paging occasion in a period of a second PTW determined based on the third information and the fourth information.

10. The method according to claim 6, wherein the core network device is an access and mobility management function (AMF).

11. A terminal comprising:
receiving circuitry configured to receive, from a base station, a radio resource control (RRC) release message including first information indicating an extended Discontinuous Reception (eDRX) cycle for an RRC inactive state and second information indicating a length of a PTW for the RRC inactive state; and
control circuitry configured to determine a first hyper-system frame number (H-SFN) of a first paging hyperframe (PH) based on the first information in the RRC inactive state, determine an ending position of a first PTW in the first PH based on the second information, and monitor physical downlink control channel candidates in a paging occasion in a period of the first PTW,
wherein the receiving circuitry is configured to receive, from a core network device, a Non Access Stratum (NAS) message including third information indicating the eDRX cycle and fourth information indicating the length of the PTW,
the control circuitry is configured to determine a second H-SFN of a second PH based on the third information in an RRC idle state, determine an ending position of the second PTW in the second PH based on the fourth information, and monitor physical downlink control channel candidates in a paging occasion in a period of the second PTW, and
the eDRX cycle for the RRC inactive state and the length of the PTW for the RRC inactive state are notified to the core network device from the base station.

12. The terminal according to claim 11, wherein the eDRX cycle for the RRC inactive state and the length of the PTW for the RRC inactive state are included in an N2 message.

13. The terminal according to claim 11, wherein the core network device is an access and mobility management function (AMF).
